(19) United States
(12) Patent Application Publication
(10) Pub. No.: US 2025/0016605 A1
(43) Pub. Date: Jan. 9, 2025

(54) METHOD FOR TRANSMITTING UPLINK SHARED CHANNEL, AND APPARATUS

(71) Applicant: LG ELECTRONICS INC., Seoul (KR)

(72) Inventors: Jongku LEE, Seoul (KR); Dongsun LEE, Seoul (KR); Byounggill KIM, Seoul (KR); Sunam KIM, Seoul (KR); Taehowan HONG, Seoul (KR); Hyunmin KIM, Seoul (KR)

(73) Assignee: LG ELECTRONICS INC., Seoul (KR)

(21) Appl. No.: 18/710,593

(22) PCT Filed: Nov. 16, 2021
(86) PCT No.: PCT/KR2021/016734

§ 371 Date: May 15, 2024

(51) Int. Cl. H04W 28/02; H04W 72/1268; H04W 72/543

(52) U.S. Cl. CPC H04W 28/0257; H04W 28/0268; H04W 72/1268; H04W 72/543

(57) ABSTRACT

Provided are a method by which a terminal transmits a physical uplink shared channel in a wireless communication system, and an apparatus. The terminal receives a logical channel MCS-related value for each of a plurality of logical channels and a physical channel MCS value for each of a plurality of PUSCHs. The terminal uses the logical channel MCS-related value and the physical channel MCS value so as to transmit each of the plurality of logical channels only through a PUSCH having a physical channel MCS value not exceeding a corresponding logical channel MCS value.

### CROSS-REFERENCE TO RELATED APPLICATION(S)

This application is the National Stage filing under 35 U.S.C. 371 of International Application No. PCT/KR2021/016734, filed on Nov. 16, 2021, the contents of which are all incorporated by reference herein in its entirety.

### TECHNICAL FIELD

This specification relates to a method and device for transmitting an uplink shared channel in a wireless communication system.

### BACKGROUND

3rd Generation Partnership Project (3GPP) Long-Term Evolution (LTE) is a technology to enable high-speed packet communication. Many methods have been proposed to achieve the LTE goals of reducing costs for users and operators, improving service quality, expanding coverage, and increasing system capacity. 3GPP LTE requires lower cost per bit, improved service usability, flexible use of frequency bands, simple structure, open interface, and appropriate power consumption of the user equipment (UE) as high-level requirements.

Work has begun at the International Telecommunication Union (ITU) and 3GPP to develop requirements and specifications for New Radio (NR) systems. 3GPP needs to identify and develop the technical components required to successfully standardize NR that satisfies both urgent market needs and the longer-term requirements set out by the ITU Radio Communication Sector (ITU-R) International Mobile Telecommunications (IMT)-2020 process in a timely manner. Additionally, NR should be able to use any spectrum band up to at least 100 GHz, which can be used for wireless communications even in the distant future.

NR targets a single technology framework that covers all deployment scenarios, usage scenarios, and requirements, including enhanced Mobile BroadBand (eMBB), massive Machine Type-Communications (mMTC), Ultra-Reliable and Low Latency Communications (URLLC), and more. NR should be inherently forward compatible.

As wireless communication technologies and User Equipment (UE) technologies evolve, there is an increasing need to provide multiple services requiring different Quality of Service (QoS) from a single UE and/or to provide a single service consisting of features requiring different QoS. As an example of providing multiple services requiring different QoS on a single UE, a smartphone user may use a Social Networking Service (SNS) or browse the Internet while watching a video. An example of providing a single service consisting of features requiring different QoS is an AR/VR service that provides visual and auditory data, which require different data transmission rates and latencies. Meanwhile, the number of devices connecting to wireless communication networks is increasing rapidly as various types of devices, including autonomous vehicles as well as devices used directly by humans such as smartphones, require wireless communication capabilities. As a result, there is a growing need for wireless access technologies that can support multiple QoS transmissions to multiple UEs.

Meanwhile, future wireless communication systems will use higher frequency carriers. As the frequency of the carrier increases, phase noise becomes a major factor that degrades the performance of the communication system. To address this, wider subcarrier spacing (SCS) is used as the frequency of the carrier increases. For the same number of subcarriers, the larger the SCS, the shorter the length of a symbol and a slot consisting of multiple symbols. If the device tries to receive the control channel every slot, the power consumption of the device increases as the slot length decreases. As a solution to this problem, it is proposed that the device attempts to receive the control channel every few slots instead of every slot. By increasing the number of times the control channel is received, the power consumption of the UE can be prevented from increasing, but the data transmission rate is reduced.

To support this, multiple Transmission Time Interval (TTI) scheduling may be used, which allows multiple data channels (e.g., physical downlink shared channel (PDSCH), physical uplink shared channel (PUSCH)) to be scheduled with a single DCI. In multiple TTI scheduling, the modulation and coding scheme (MCS) for each PUSCH may be determined and communicated by considering the size and QoS of the data to be transmitted over each PUSCH. The data size and QoS may be provided to the base station through a Buffer Status Report (BSR) reported by the UE to the base station.

However, after the UE reports the BSR to the base station, new data to be transmitted by the UE may be introduced into the buffer, causing the BSR and the actual buffer state of the UE to differ. In this case, according to the conventional multiple TTI scheduling, the specific data may be transmitted via PUSCH, which cannot satisfy the QoS of the specific data.

In addition, even if buffer state inconsistencies do not occur, transmission quality degradation may occur when conventional prioritised bit rate (PBR)-based scheduling algorithms, i.e., scheduling data to satisfy the PBR for all logical channels first, and remaining radio resources are given the opportunity to be used sequentially, starting with the highest priority logical channel, are applied to multi-TTI scheduling.

### SUMMARY

After the UE reports the buffer status report (BSR) to the base station, it may occur that the BSR and the actual buffer status of the UE are different for various reasons. In this case, applying conventional multiple TTI scheduling may cause a problem that the specific data is transmitted via PUSCH, which cannot satisfy the QoS of the specific data. Also, if the conventional PBR (Prioritised Bit Rate) based scheduling algorithm is applied to the multi-TTI scheduling as it is, transmission quality degradation may occur.

As such, when applying multiple TTI scheduling, in which a plurality of PUSCHs can be scheduled with one DCI, there may be a case where the specific data is transmitted via a PUSCH that cannot satisfy the QoS of the specific data. To provide a multiple TTI scheduling method that can solve these problems, and a PUSCH transmission method and apparatus according to the method.

To address the above problems, a method for transmitting a PUSCH that takes into account a logical channel MCS value and a physical channel MCS value is provided.

In one aspect, a UE receives a logical channel MCS related value for each of a plurality of logical channels via a higher layer signal, and a physical channel MCS value for each of a plurality of PUSCHs via one DCI related with scheduling of the plurality of PUSCHs. Using the logical channel MCS related value and the physical channel MCS value, the UE transmits each of the plurality of logical channels only via a PUSCH having a physical channel MCS value that does not exceed the corresponding logical channel MCS value.

In another aspect, an apparatus implementing the above method is provided.

The present disclosure may have various effects.

For example, when a plurality of data with different target BLERs are scheduled in a single DCI and transmitted over a plurality of PUSCHs, they can be transmitted over PUSCHs that satisfy the QoS of each data.

Also, in a DCI for multiple TTI scheduling that schedules multiple data channels, it is possible to transmit over PUSCHs that satisfy the QoS of each data while minimising the size increase.

Effects that can be obtained through specific examples of the present specification are not limited to the effects listed above. For example, various technical effects that a person having ordinary skill in the related art can understand or derive from this specification may exist. Accordingly, the specific effects of the present specification are not limited to those explicitly described herein, and may include various effects that can be understood or derived from the technical characteristics of the present specification.

### BRIEF DESCRIPTION OF THE DRAWINGS

FIG. 1 illustrates an example communication system to which an implementation of the present disclosure is applicable.

FIG. 2 illustrates an example of a wireless device to which an implementation of the present disclosure is applicable.

FIG. 3 illustrates an example of a wireless device to which an implementation of the present disclosure applies.

FIG. 4 illustrates an example of a UE to which an implementation of the present disclosure is applicable.

FIGS. 5 and 6 illustrate examples of protocol stacks in a 3GPP-based wireless communication system to which an implementation of the present disclosure is applicable.

FIG. 7 illustrates physical channels used in a 3GPP system and a typical signal transmission.

FIG. 8 illustrates a frame structure in a 3GPP-based wireless communication system to which an implementation of the present disclosure is applicable.

FIG. 9 illustrates a slot structure of a frame, according to one embodiment of the present disclosure.

FIG. 10 illustrates an example of conventional multiple TTI scheduling, wherein a plurality of PUSCHs are scheduled with a single DCI.

FIG. 11 illustrates a multi-TTI multi-MCS scheduling DCI.

FIG. 12 illustrates a case where there is a mismatch between the buffer state information used by the base station for scheduling and the actual buffer state of the UE.

FIG. 13 illustrates an example of using priority index information to improve the transmission quality degradation caused by the buffer state mismatch.

FIG. 14 illustrates an example of transmission quality degradation due to buffer state mismatch in a multi-TTI multi-MCS transmission.

FIG. 15 shows an example of a mismatch between the transmission expected by the base station scheduling and the actual transmission by the UE.

FIG. 16 illustrates an example where quality degradation occurs when applying conventional PBR-based scheduling in a multi-TTI multi-MCS transmission.

FIG. 17 illustrates a method of physical uplink shared channel (PUSCH) transmission of a UE in a wireless communication system according to one embodiment of the present disclosure.

FIG. 18 illustrates a signalling process between a base station and a UE according to the method of FIG. 17.

FIG. 19 is an example of determining a transmittable PUSCH(s) for each logical channel.

FIG. 20 illustrates a procedure for updating logical channel configurations in response to a change in channel status.

FIG. 21 illustrates the maximum data size that can be transmitted for each logical channel.

FIG. 22 illustrates an example of a UE transmitting a logical channel over a plurality of PUSCHs in order of priority.

FIG. 23 illustrates a scheduling procedure of the UE.

### DETAILED DESCRIPTION

The following techniques, devices and systems may be applied to a variety of wireless multiple access systems. Examples of multiple access systems include Code Division Multiple Access (CDMA) systems, Frequency Division Multiple Access (FDMA) systems, Time Division Multiple Access (TDMA) systems, Orthogonal Frequency Division Multiple Access (OFDMA) systems, and Single Access (SC-FDMA) systems. It includes a Carrier Frequency Division Multiple Access (MC-FDMA) system and a Multi-Carrier Frequency Division Multiple Access (MC-FDMA) system. CDMA can be implemented through wireless technologies such as Universal Terrestrial Radio Access (UTRA) or CDMA2000. TDMA can be implemented over wireless technologies such as Global System for Mobile communications (GSM), General Packet Radio Service (GPRS), or Enhanced Data rates for GSM Evolution (EDGE). OFDMA can be implemented through wireless technologies such as Institute of Electrical and Electronics Engineers (IEEE) 802.11 (Wi-Fi), IEEE 802.16 (WiMAX), IEEE 802.20, or Evolved UTRA (E-UTRA). UTRA is part of the Universal Mobile Telecommunications System (UMTS). 3rd Generation Partnership Project (3GPP) Long-Term Evolution (LTE) is part of Evolved UMTS (E-UMTS) using E-UTRA. 3GPP LTE uses OFDMA in the downlink (DL) and SC-FDMA in the uplink (UL). The evolution of 3GPP LTE includes LTE-A (Advanced), LTE-A Pro, and/or 5G NR (New Radio).

For convenience of explanation, implementations herein are primarily described in relation to a 3GPP based wireless communication system. However, the technical features of this specification are not limited to this. For example, the following detailed description is provided based on a mobile communication system corresponding to a 3GPP-based wireless communication system, but aspects of the present specification that are not limited to a 3GPP-based wireless communication system can be applied to other mobile communication systems.

For terms and technologies not specifically described among the terms and technologies used in this specification, reference may be made to wireless communication standard documents published prior to this specification.

In the present specification, “A or B” may mean “only A”, “only B” or “both A and B”. In other words, in the present specification, “A or B” may be interpreted as “A and/or B”. For example, in the present specification, “A, B, or C” may mean “only A”, “only B”, “only C”, or “any combination of A, B, C”.

A slash (/) or comma used in the present specification may mean “and/or”. For example, “A/B” may mean “A and/or B”. Accordingly, “A/B” may mean “only A”, “only B”, or “both A and B”. For example, “A, B, C” may mean “A, B, or C”.

In the present specification, “at least one of A and B” may mean “only A”, “only B”, or “both A and B”. In addition, in the present specification, the expression “at least one of A or B” or “at least one of A and/or B” may be interpreted as “at least one of A and B”.

In addition, in the present specification, “at least one of A, B, and C” may mean “only A”, “only B”, “only C”, or “any combination of A, B, and C”. In addition, “at least one of A, B, or C” or “at least one of A, B, and/or C” may mean “at least one of A, B, and C”.

In addition, a parenthesis used in the present specification may mean “for example”. Specifically, when indicated as “control information (PDCCH)”, it may mean that “PDCCH” is proposed as an example of the “control information”. In other words, the “control information” of the present specification is not limited to “PDCCH”, and “PDCCH” may be proposed as an example of the “control information”. In addition, when indicated as “control information (i.e., PDCCH)”, it may also mean that “PDCCH” is proposed as an example of the “control information”.

Technical features described individually in one drawing in this specification may be implemented individually or simultaneously.

Although not limited thereto, various descriptions, functions, procedures, suggestions, methods and/or operational flow diagrams disclosed herein may be applied to various fields requiring wireless communication and/or connectivity (e.g., 5G) between devices.

Hereinafter, this specification will be described in more detail with reference to the drawings. In the following drawings and/or descriptions, like reference numbers may refer to identical or corresponding hardware blocks, software blocks and/or functional blocks, unless otherwise indicated.

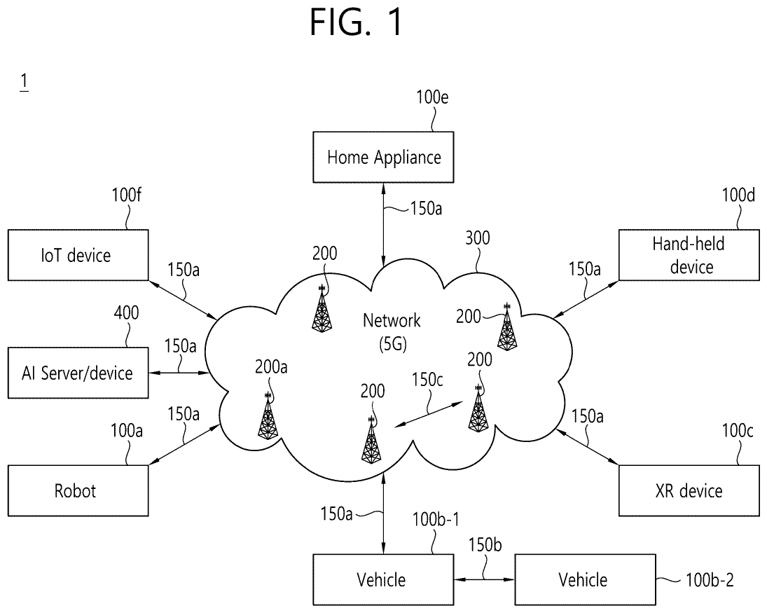

FIG. 1 illustrates an example communication system to which an implementation of the present disclosure may be applied.

The 5G usage scenario shown in FIG. 1 is illustrative only, and the technical features of the present disclosure may be applicable to other 5G usage scenarios not shown in FIG. 1.

There are three main categories of requirements for 5G: (1) enhanced Mobile BroadBand (eMBB) category, (2) massive Machine Type Communication (mMTC) category, and (3) Ultra-Reliable and Low Latency Communications (URLLC) category.

Referring to FIG. 1, a communication system 1 includes wireless devices 100a-100f, a base station (BS; 200), and a network 300. While FIG. 1 illustrates a 5G network as an example of the network of the communication system 1, implementations of the present disclosure are not limited to 5G systems and may be applicable to future communication systems beyond 5G systems.

The base station 200 and network 300 may be implemented as wireless devices, and certain wireless devices may operate as base station/network nodes in relation to other wireless devices.

The wireless devices 100a-100f represent devices that perform communication using radio access technology (RAT) (e.g., 5G NR or LTE), and may also be referred to as communication/wireless/5G devices. Wireless devices 100a to 100f may include, but are not limited to, robots 100a, vehicles 100b-1 and 100b-2, eXtended Reality (XR) devices 100c, portable devices 100d, consumer electronics devices 100e, Internet-Of-Things (IoT) devices 100f, and artificial intelligence (AI) devices/servers 400. For example, vehicles may include vehicles with wireless communication capabilities, autonomous vehicles, and vehicles capable of performing vehicle-to-vehicle communication. The vehicles may include unmanned aerial vehicles (UAVs) (e.g., drones). XR devices may include augmented reality (AR)/virtual reality (VR)/mixed reality (MR) devices, and may be implemented in the form of head-mounted devices (HMDs), head-up displays (HUDs) mounted on vehicles, televisions, smartphones, computers, wearable devices, consumer electronics, digital signs, vehicles, robots, and the like. Portable devices can include smartphones, smart pads, wearable devices (e.g., smart watches or smart glasses), and computers (e.g., laptops). Home appliances can include TVs, refrigerators, and washing machines. IoT devices can include sensors and smart meters.

In the present disclosure, the wireless devices 100a-100f may be referred to as user equipment (UE). UEs may include, for example, mobile phones, smartphones, notebook computers, digital broadcast terminals, personal digital assistants (PDAs), portable multimedia players (PMPs), navigation systems, slate PCs, tablet PCs, ultrabooks, vehicles, vehicles with autonomous driving capabilities, connected cars, UAVs, AI modules, robots, AR devices, VR devices, MR devices, holographic devices, public safety devices, MTC devices, IoT devices, medical devices, fintech devices (or financial devices), security devices, weather/environmental devices, devices related to 5G services, or devices related to the Fourth Industrial Revolution.

For example, a UAV may be an aircraft that is not manned and is navigated by radio control signals.

For example, a VR device may include a device for implementing an object or background of a virtual environment. For example, an AR device may include a device for implementing objects or backgrounds in a virtual world by linking objects or backgrounds in the virtual world to objects or backgrounds in the real world. For example, an MR device may include a device implemented by merging an object or a background in a virtual world with an object or a background in the real world. For example, a holographic device may include a device for recording and playing back stereoscopic information to create a 360-degree stereoscopic image using the phenomenon of light interference that occurs when two laser lights meet, called a hologram.

For example, a public safety device may include an image relay device or an imaging device that can be worn on a user's body.

For example, MTC devices and IoT devices may be devices that do not require direct human intervention or operation. For example, MTC devices and IoT devices may include smart meters, vending machines, thermometers, smart light bulbs, door locks, or various sensors.

For example, a medical device may be a device used for the purpose of diagnosing, treating, alleviating, curing, or preventing disease. For example, a medical device may be a device used to diagnose, treat, alleviate, cure, or correct an injury or damage. For example, a medical device may be a device used for the purpose of examining, replacing, or modifying a structure or function. For example, a medical device may be a device used for the purpose of adjusting a pregnancy. For example, a medical device may include a therapeutic device, a driving device, an (in vitro) diagnostic device, a hearing aid, or a procedural device.

For example, a security device may be a device installed to prevent possible harm and maintain safety. For example, a security device may be a camera, closed circuit television (CCTV), recorder, or dashcam.

For example, a fintech device can be a device that can provide financial services, such as mobile payments. For example, a fintech device may include a payment device or a point-of-sale system.

For example, a weather/environment device may include a device that monitors or predicts the weather/environment.

The wireless devices 100a-100f may be connected to the network 300 via the base station 200. The wireless devices 100a-100f may be equipped with AI technology, and the wireless devices 100a-100f may be connected to an AI server 400 via the network 300. The network 300 may be configured using a 3G network, a 4G (e.g., LTE) network, a 5G (e.g., NR) network, and a post-5G network, among others. The wireless devices 100a-100f may communicate with each other via the base station 200/network 300, but may also communicate directly (e.g., sidelink communication) without going through the base station 200/network 300. For example, vehicles 100b-1, 100b-2 may communicate directly (e.g., vehicle-to-vehicle (V2V)/vehicle-to-everything (V2X) communication). Further, IoT devices (e.g., sensors) may communicate directly with other IoT devices (e.g., sensors) or other wireless devices 100a-100f.

Wireless communications/connections 150a, 150b, 150c may be established between the wireless devices 100a-100f and/or between the wireless devices 100a-100f and the base station 200 and/or between the base station 200 and the wireless devices 100a-100f. Here, the wireless communications/connections may be established via various RATs (e.g., 5G NR), such as uplink/downlink communications 150a, sidelink communications 150b (or, device-to-device (D2D) communications), inter-base station communications 150c (e.g., relay, integrated access and backhaul (IAB)), and the like. Through the wireless communications/connections 150a, 150b, 150c, the wireless devices 100a-100f and the base station 200 may transmit/receive wireless signals to/from each other. For example, the wireless communications/connections 150a, 150b, 150c may transmit/receive signals via various physical channels. To this end, based on various proposals herein, at least some of the following may be performed: various configuration information setting processes for transmitting/receiving wireless signals, various signal processing processes (e.g., channel encoding/decoding, modulation/demodulation, resource mapping/demapping, etc.), and resource allocation processes.

AI refers to the field of study of artificial intelligence or the methodologies for creating it, while machine learning refers to the field of study that defines the various problems addressed by the field of artificial intelligence and the methodologies for solving them. Machine learning can also be defined as an algorithm that improves its performance on a task through constant experience with that task.

A robot can be defined as a machine that automatically processes or performs a given task due to its own capabilities. In particular, robots that have the ability to perceive their environment and perform actions based on their own judgement are called intelligent robots. Robots can be classified into industrial, medical, domestic, military, etc. depending on their purpose or field of use. Robots can perform various physical actions, such as moving robot joints, by having a drive unit that includes an actuator or motor. In addition, mobile robots may have wheels, brakes, propellers, etc. in the drive unit, which allows them to drive on the ground or fly in the air.

Autonomous driving refers to technology that drives itself, while an autonomous vehicle is a vehicle that drives without or with minimal human intervention. For example, autonomous driving can include technology that stays in the lane it is travelling in, automatically adjusts its speed, such as adaptive cruise control, automatically follows a set route, or automatically routes itself once a destination is set. Vehicles include vehicles with only internal combustion engines, hybrid vehicles with both internal combustion engines and electric motors, and electric vehicles with only electric motors, and can include not only cars but also trains, motorcycles, etc. Autonomous vehicles can be thought of as robots with autonomous driving capabilities.

Extended reality refers to VR, AR, and MR. VR technology provides only CG images of real-world objects or backgrounds, AR technology provides CG images of virtual objects on top of real-world images, and MR technology is a CG technology that blends and combines virtual objects in the real world. MR technology is similar to AR technology in that it shows real objects and virtual objects together. However, the difference is that in AR technology, virtual objects are used as a complement to real objects, while in MR technology, virtual objects and real objects are used as equals.

NR supports multiple numerologies or subcarrier spacings (SCS) to support different 5G services. For example, an SCS of 15 kHz supports wide area in the traditional cellular bands; an SCS of 30 kHz/60 kHz supports dense-urban, lower latency and wider carrier bandwidth; and an SCS of 60 kHz or higher supports bandwidths greater than 24.25 GHz to overcome phase noise.

The NR frequency band can be defined as two types of frequency ranges (FR1, FR2). The values of the frequency range may vary. For example, the frequency ranges of the two types (FR1, FR2) may be as shown in Table 1 below. For convenience of explanation, among the frequency ranges used in the NR system, FR1 may mean “sub 6 GHz range” and FR2 may mean “above 6 GHz range” and may be referred to as MilliMeter Wave (mmW).

TABLE 1

| Frequency range | | |
|---|---|---|
| designation | Frequency range | Subcarrier spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system can be changed. For example, FR1 may include a band of 410 MHz to 7125 MHz as shown in Table 2 below. That is, FR1 may include a frequency band of 6 GHz (or 5850, 5900, 5925 MHz, etc.). For example, the frequency band above 6 GHz (or 5850, 5900, 5925 MHz, etc.) included within FR1 may include an unlicensed band. Unlicensed bands can be used for a variety of purposes, for example for communications for vehicles (e.g. autonomous driving).

TABLE 2

| Frequency range | | |
|---|---|---|
| designation | Frequency range | Subcarrier spacing |
| FR1 | 410 MHz-7125 MHz | 15, 30, 60 kHz |
| FR2 | 24250 MHz-52600 MHz | 60, 120, 240 kHz |

Here, wireless communication technologies implemented in the wireless device of this specification may include NarrowBand IoT (NB-IoT) for low-power communication as well as LTE, NR, and 6G. For example, NB-IoT technology may be an example of LPWAN (Low Power Wide Area Network) technology and may be implemented in standards such as LTE Cat NB1 and/or LTE Cat NB2, and is not limited to the above-mentioned names. Additionally or alternatively, the wireless communication technology implemented in the wireless device of the present specification may perform communication based on LTE-M technology. For example, LTE-M technology may be an example of LPWAN technology and may be called various names such as enhanced MTC (eMTC). For example, LTE-M technology may be implemented in at least one of a variety of specifications, including 1) LTE CAT 0, 2) LTE Cat M1, 3) LTE Cat M2, 4) LTE non-Bandwidth Limited (non-BL), 5) LTE-MTC, 6) LTE MTC, and/or 7) LTE M, and is not limited to the above designations. Additionally or alternatively, the wireless communication technologies implemented in the wireless devices of the present disclosure may include at least one of ZigBee, Bluetooth, and/or LPWAN with consideration for low power communication, and are not limited to the above designations. For example, Zigbee technology can create Personal Area Networks (PANs) for small/low-power digital communications based on various specifications such as IEEE 802.15.4, which can go by many names.

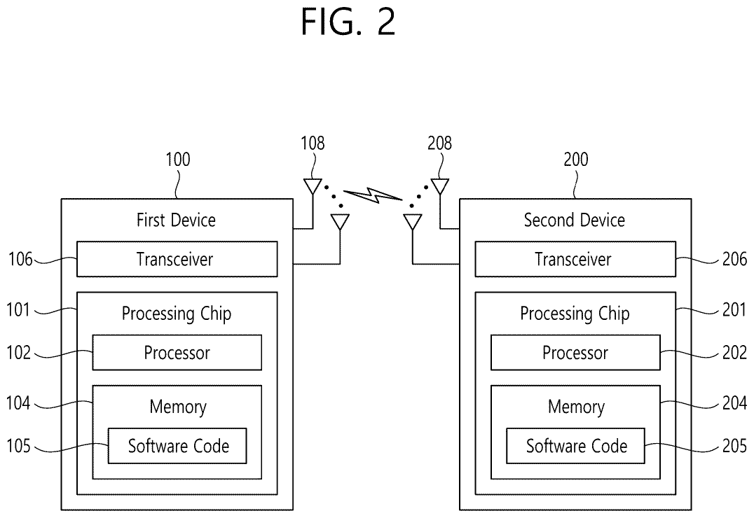

FIG. 2 illustrates an example wireless device to which an implementation of the present disclosure is applicable.

Referring to FIG. 2, the first wireless device 100 and the second wireless device 200 may transmit and receive wireless signals to/from external devices via various RATs (e.g., LTE and NR).

In FIG. 2, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1.

The first wireless device 100 may include at least one transceiver, such as a transceiver 106, at least one processing chip, such as a processing chip 101, and/or one or more antennas 108.

The processing chip 101 may include at least one processor, such a processor 102, and at least one memory, such as a memory 104. It is exemplarily shown in FIG. 2 that the memory 104 is included in the processing chip 101. Additional and/or alternatively, the memory 104 may be placed outside of the processing chip 101.

The processor 102 may control the memory 104 and/or the transceiver 106 and may be configured to implement the descriptions, functions, procedures, suggestions, methods and/or operational flowcharts described in the present disclosure. For example, the processor 102 may process information within the memory 104 to generate first information/signals and then transmit radio signals including the first information/signals through the transceiver 106. The processor 102 may receive radio signals including second information/signals through the transceiver 106 and then store information obtained by processing the second information/signals in the memory 104.

The memory 104 may be operably connectable to the processor 102. The memory 104 may store various types of information and/or instructions. The memory 104 may store a software code 105 which implements instructions that, when executed by the processor 102, perform the descriptions, functions, procedures, suggestions, methods and/or operational flowcharts disclosed in the present disclosure. For example, the software code 105 may implement instructions that, when executed by the processor 102, perform the descriptions, functions, procedures, suggestions, methods and/or operational flowcharts disclosed in the present disclosure. For example, the software code 105 may control the processor 102 to perform one or more protocols. For example, the software code 105 may control the processor 102 to perform one or more layers of the radio interface protocol.

Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. Each of the transceiver 106 may include a transmitter and/or a receiver. The transceiver 106 may be interchangeably used with Radio Frequency (RF) unit(s). In the present disclosure, the first wireless device 100 may represent a communication modem/circuit/chip.

The second wireless device 200 may include at least one transceiver, such as a transceiver 206, at least one processing chip, such as a processing chip 201, and/or one or more antennas 208.

The processing chip 201 may include at least one processor, such a processor 202, and at least one memory, such as a memory 204. It is exemplarily shown in FIG. 2 that the memory 204 is included in the processing chip 201. Additional and/or alternatively, the memory 204 may be placed outside of the processing chip 201.

The processor 202 may control the memory 204 and/or the transceiver 206 and may be configured to implement the descriptions, functions, procedures, suggestions, methods and/or operational flowcharts described in the present disclosure. For example, the processor 202 may process information within the memory 204 to generate third information/signals and then transmit radio signals including the third information/signals through the transceiver 206. The processor 202 may receive radio signals including fourth information/signals through the transceiver 106 and then store information obtained by processing the fourth information/signals in the memory 204.

The memory 204 may be operably connectable to the processor 202. The memory 204 may store various types of information and/or instructions. The memory 204 may store a software code 205 which implements instructions that, when executed by the processor 202, perform the descriptions, functions, procedures, suggestions, methods and/or operational flowcharts disclosed in the present disclosure. For example, the software code 205 may implement instructions that, when executed by the processor 202, perform the descriptions, functions, procedures, suggestions, methods and/or operational flowcharts disclosed in the present disclosure. For example, the software code 205 may control the processor 202 to perform one or more protocols. For example, the software code 205 may control the processor 202 to perform one or more layers of the radio interface protocol.

Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. Each of the transceiver 206 may include a transmitter and/or a receiver. The transceiver 206 may be interchangeably used with RF unit. In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as physical (PHY) layer, Media Access Control (MAC) layer, Radio Link Control (RLC) layer, Packet Data Convergence Protocol (PDCP) layer, Radio Resource Control (RRC) layer, and Service Data Adaptation Protocol (SDAP) layer). The one or more processors 102 and 202 may generate one or more Protocol Data Units (PDUs) and/or one or more Service Data Units (SDUs) according to the descriptions, functions, procedures, suggestions, methods and/or operational flowcharts disclosed in the present disclosure. The one or more processors 102 and 202 may generate messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, suggestions, methods and/or operational flowcharts disclosed in the present disclosure may be implemented using firmware or software and the firmware or software may be configured to include the modules, procedures, or functions. Firmware or software configured to perform the descriptions, functions, procedures, suggestions, methods and/or operational flowcharts disclosed in the present disclosure may be included in the one or more processors 102 and 202 or stored in the one or more memories 104 and 204 so as to be driven by the one or more processors 102 and 202. The descriptions, functions, procedures, suggestions, methods and/or operational flowcharts disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable ROMs (EEPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas 108 and 208 may be a plurality of physical antennas or a plurality of logical antennas (e.g., antenna ports).

The one or more transceivers 106 and 206 may convert received user data, control information, radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the one or more transceivers 106 and 206 can up-convert OFDM baseband signals to OFDM signals by their (analog) oscillators and/or filters under the control of the one or more processors 102 and 202 and transmit the up-converted OFDM signals at the carrier frequency. The one or more transceivers 106 and 206 may receive OFDM signals at a carrier frequency and down-convert the OFDM signals into OFDM baseband signals by their (analog) oscillators and/or filters under the control of the one or more processors 102 and 202.

In the implementations of the present disclosure, a UE may operate as a transmitting device in UL and as a receiving device in DL. In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be configured to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be configured to perform the BS behavior according to an implementation of the present disclosure or control the transceiver(s) 206 to perform the BS behavior according to an implementation of the present disclosure.

In the present disclosure, a BS is also referred to as a Node B (NB), an eNode B (eNB), or a gNB.

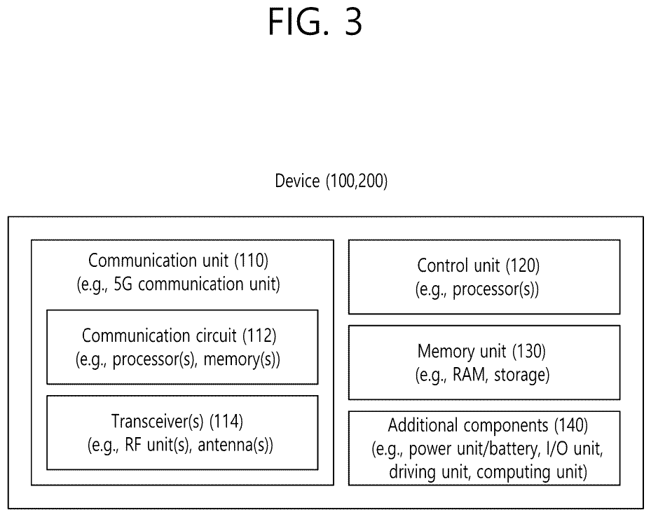

FIG. 3 shows an example of a wireless device to which implementations of the present disclosure are applied.

The wireless device may be implemented in various forms according to a use-case/service.

Referring to FIG. 3, wireless devices 100 and 200 may correspond to the wireless devices 100 and 200 of FIG. 2 and may be configured by various elements, components, units/portions, and/or modules. For example, each of the wireless devices 100 and 200 may include a communication unit 110, a control unit 120, a memory unit 130, and additional components 140. The communication unit 110 may include a communication circuit 112 and transceiver(s) 114. For example, the communication circuit 112 may include the one or more processors 102 and 202 of FIG. 2 and/or the one or more memories 104 and 204 of FIG. 2. For example, the transceiver(s) 114 may include the one or more transceivers 106 and 206 of FIG. 2 and/or the one or more antennas 108 and 208 of FIG. 2. The control unit 120 is electrically connected to the communication unit 110, the memory unit 130, and the additional components 140 and controls overall operation of each of the wireless devices 100 and 200. For example, the control unit 120 may control an electric/mechanical operation of each of the wireless devices 100 and 200 based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of the wireless devices 100 and 200. For example, the additional components 140 may include at least one of a power unit/battery, Input/Output (I/O) unit (e.g., audio I/O port, video I/O port), a driving unit, and a computing unit. The wireless devices 100 and 200 may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1), a digital broadcast terminal, a hologram device, a public safety device, an MTC device, a medicine device, a FinTech device (or a finance device), a security device, a climate/environment device, the AI server/device (400 of FIG. 1), the BSs (200 of FIG. 1), a network node, etc. The wireless devices 100 and 200 may be used in a mobile or fixed place according to a use-example/service.

In FIG. 3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an Application Processor (AP), an Electronic Control Unit (ECU), a Central Processing Unit (CPU), a Graphical Processing Unit (GPU), and a memory control processor. As another example, the memory unit 130 may be configured by a RAM, a Dynamic RAM (DRAM), a ROM, a flash memory, a volatile memory, a non-volatile memory, and/or a combination thereof.

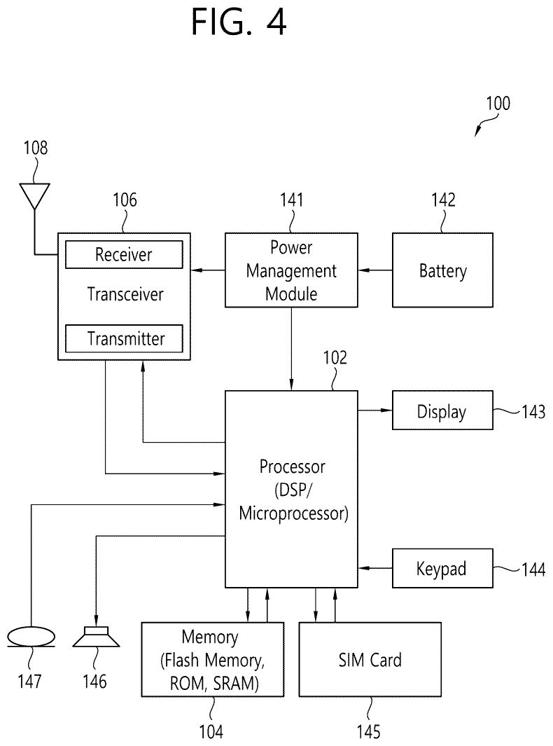

FIG. 4 shows an example of UE to which implementations of the present disclosure are applied.

Referring to FIG. 4, a UE 100 may correspond to the first wireless device 100 of FIG. 2 and/or the wireless device 100 or 200 of FIG. 3.

A UE 100 includes a processor 102, a memory 104, a transceiver 106, one or more antennas 108, a power management module 141, a battery 142, a display 143, a keypad 144, a Subscriber Identification Module (SIM) card 145, a speaker 146, and a microphone 147.

The processor 102 may be configured to implement the descriptions, functions, procedures, suggestions, methods and/or operational flowcharts disclosed in the present disclosure. The processor 102 may be configured to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of DSP, CPU, GPU, a modem (modulator and demodulator).

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 141 manages power for the processor 102 and/or the transceiver 106. The battery 142 supplies power to the power management module 141.

The display 143 outputs results processed by the processor 102. The keypad 144 receives inputs to be used by the processor 102. The keypad 144 may be shown on the display 143.

The SIM card 145 is an integrated circuit that is intended to securely store the International Mobile Subscriber Identity (IMSI) number and its related key, which are used to identify and authenticate subscribers on mobile telephony devices (such as mobile phones and computers). It is also possible to store contact information on many SIM cards.

The speaker 146 outputs sound-related results processed by the processor 102. The microphone 147 receives sound-related inputs to be used by the processor 102.

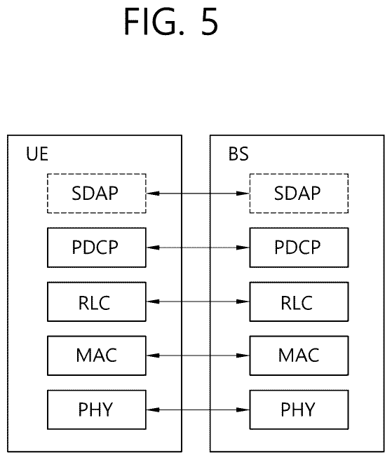

FIGS. 5 and 6 show an example of protocol stacks in a 3GPP based wireless communication system to which implementations of the present disclosure are applied.

In particular, FIG. 5 illustrates an example of a radio interface user plane protocol stack between a UE and a BS and FIG. 6 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 5, the user plane protocol stack may be divided into Layer 1 (i.e., a PHY layer) and Layer 2. Referring to FIG. 6, the control plane protocol stack may be divided into Layer 1 (i.e., a PHY layer), Layer 2, Layer 3 (e.g., an RRC layer), and a Non-Access Stratum (NAS) layer. Layer 1, Layer 2 and Layer 3 are referred to as an Access Stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network Quality of Service (QoS) flows.

In the 3GPP NR system, the main services and functions of the MAC sublayer include: mapping between logical channels and transport channels; multiplexing/de-multiplexing of MAC SDUs belonging to one or different logical channels into/from Transport Blocks (TB) delivered to/from the physical layer on transport channels; scheduling information reporting; error correction through Hybrid Automatic Repeat reQuest (HARQ) (one HARQ entity per cell in case of Carrier Aggregation (CA)); priority handling between UEs by means of dynamic scheduling; priority handling between logical channels of one UE by means of logical channel prioritization; padding. A single MAC entity may support multiple numerologies, transmission timings and cells. Mapping restrictions in logical channel prioritization control which numerology(ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast Control Channel (BCCH) is a downlink logical channel for broadcasting system control information, Paging Control Channel (PCCH) is a downlink logical channel that transfers paging information, system information change notifications and indications of ongoing Public Warning Service (PWS) broadcasts, Common Control Channel (CCCH) is a logical channel for transmitting control information between UEs and network and used for UEs having no RRC connection with the network, and Dedicated Control Channel (DCCH) is a point-to-point bi-directional logical channel that transmits dedicated control information between a UE and the network and used by UEs having an RRC connection. Dedicated Traffic Channel (DTCH) is a point-to-point logical channel, dedicated to one UE, for the transfer of user information. A DTCH can exist in both uplink and downlink. In downlink, the following connections between logical channels and transport channels exist: BCCH can be mapped to Broadcast Channel (BCH); BCCH can be mapped to Downlink Shared Channel (DL-SCH); PCCH can be mapped to Paging Channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to Uplink Shared Channel (UL-SCH); DCCH can be mapped to UL-SCH; and DTCH can be mapped to UL-SCH.

The RLC sublayer supports three transmission modes: Transparent Mode (TM), Unacknowledged Mode (UM), and Acknowledged Mode (AM). The RLC configuration is per logical channel with no dependency on numerologies and/or transmission durations. In the 3GPP NR system, the main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using Robust Header Compression (ROHC); transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data; reordering and duplicate detection; in-order delivery; duplication of PDCP PDUs and duplicate discard indication to lower layers.

In the 3GPP NR system, the main services and functions of SDAP include: mapping between a QoS flow and a data radio bearer; marking QoS Flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5G Core network (5GC) or Next-Generation Radio Access Network (NG-RAN); establishment, maintenance and release of an RRC connection between the UE and NG-RAN; security functions including key management; establishment, configuration, maintenance and release of Signaling Radio Bearers (SRBs) and Data Radio Bearers (DRBs); mobility functions (including: handover and context transfer, UE cell selection and reselection and control of cell selection and reselection, inter-RAT mobility); QoS management functions; UE measurement reporting and control of the reporting; detection of and recovery from radio link failure; NAS message transfer to/from NAS from/to UE.

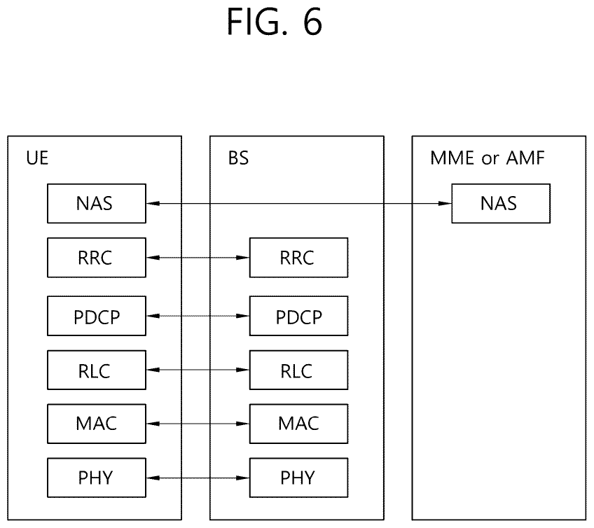

FIG. 7 illustrates physical channels and typical signal transmission used in a 3GPP system.

Referring to FIG. 7, in a wireless communication system, a UE receives information from a base station through downlink (DL), and the UE transmits information to the base station through uplink (UL). The information transmitted and received between the base station and the UE includes data and various control information, and various physical channels exist depending on the type/purpose of the information they transmit and receive.

The UE which is powered on or which newly enters a cell performs an initial cell search operation such as adjusting synchronization with the BS or the like (S11). To this end, the UE receives a primary synchronization channel (PSCH) and a secondary synchronization channel (SSCH) from the BS to adjust synchronization with the BS, and acquire information such as a cell identity (ID) or the like. In addition, the UE may receive a physical broadcast channel (PBCH) from the BS to acquire broadcasting information in the cell. In addition, the UE may receive a downlink reference signal (DL RS) in an initial cell search step to identify a downlink channel state.

Upon completing the initial cell search, the UE may receive a physical downlink control channel (PDCCH) and a physical downlink control channel (PDSCH) corresponding thereto to acquire more specific system information (S12).

Meanwhile, if there are no radio resources to connect to the base station for the first time or to transmit a signal, the UE may perform a random access procedure (RACH, which may also be referred to as a random access process) to the base station (S13 to S16). To do this, the UE may transmit a specific sequence as a preamble over the Physical Random Access Channel (PRACH) (S13 and S15) and receive a response message (Random Access Response (RAR) message) to the preamble over the PDCCH and the corresponding PDSCH. In the case of contention-based RACH, an additional conflict resolution procedure can be performed (S16).

After performing the procedure described above, the UE can then perform PDCCH/PDSCH reception (S17) and Physical Uplink Shared Channel (PUSCH)/Physical Uplink Control Channel (PUCCH) transmission (S18) as a normal uplink signal transmission procedure. In particular, the UE may receive downlink control information (DCI) via PDCCH. The DCI includes control information, such as resource allocation information for the UE, and may be formatted differently depending on the intended use.

On the other hand, the control information transmitted by the UE to the base station via the uplink or received by the UE from the base station may include downlink/uplink ACK/NACK signals, channel quality indicators (CQI), precoding matrix indices (PMI), rank indicators (RI), etc. The UE may transmit control information such as CQI/PMI/RI described above via PUSCH and/or PUCCH.

### <Structure of Uplink and Downlink Channels>

### 1. Downlink Channel Structure

The base station transmits related signals to the UE through a downlink channel described later, and the UE receives related signals from the base station through a downlink channel described later.

### (1) Physical Downlink Shared Channel (PDSCH)

PDSCH carries downlink data (e.g., DL-shared channel transport block, DL-SCH TB) and is subject to modulation methods such as Quadrature Phase Shift Keying (QPSK), 16 Quadrature Amplitude Modulation (QAM), 64 QAM, 256 QAM, etc. A codeword is generated by encoding TB. PDSCH can carry multiple codewords. Each codeword is scrambled and modulation mapped, and the modulation symbols generated from each codeword are mapped to one or more layers (Layer mapping). Each layer is mapped to resources along with DMRS (Demodulation Reference Signal), generated as an OFDM symbol signal, and transmitted through the corresponding antenna port.

### (2) Physical Downlink Control Channel (PDCCH)

PDCCH carries downlink control information (DCI) and QPSK modulation method is applied. One PDCCH consists of 1, 2, 4, 8, or 16 CCEs (Control Channel Elements) depending on the AL (Aggregation Level). One CCE consists of six REGs (Resource Element Group). One REG is defined by one OFDM symbol and one (P)RB.

The UE obtains DCI transmitted through the PDCCH by performing decoding (aka blind decoding) on a set of PDCCH candidates. The set of PDCCH candidates that the UE decodes is defined as the PDCCH search space set. The search space set may be a common search space or a UE-specific search space. The UE can obtain DCI by monitoring PDCCH candidates within one or more search space sets set by MIB or higher layer signaling.

### 2. Uplink Channel Structure

The UE transmits the relevant signals to the base station via the uplink channel described above, and the base station receives the relevant signals from the UE via the uplink channel described above.

### (1) Physical Uplink Shared Channel (PUSCH)

PUSCH carries uplink data (e.g., UL-shared channel transport block, UL-SCH TB) and/or uplink control information (UCI) and is transmitted based on a CP-OFDM (Cyclic Prefix-Orthogonal Frequency Division Multiplexing) waveform, DFT-s-OFDM (Discrete Fourier Transform-spread-Orthogonal Frequency Division Multiplexing) waveform, etc. When the PUSCH is transmitted based on the DFT-s-OFDM waveform, the UE transmits the PUSCH by applying transform precoding. For example, when transform precoding is not possible (e.g., transform precoding is disabled), the UE may transmit PUSCH based on the CP-OFDM waveform, and when transform precoding is possible (e.g., transform precoding is enabled), the UE may transmit PUSCH based on the CP-OFDM waveform or the DFT-s-OFDM waveform. PUSCH transmissions can be dynamically scheduled by UL grants within the DCI, or semi-statically scheduled based on higher layer (e.g., RRC) signaling (and/or Layer 1 (L1) signaling (e.g., PDCCH))(configured grant). PUSCH transmission can be performed based on codebook or non-codebook.

### (2) Physical Uplink Control Channel (PUCCH)

A PUCCH carries uplink control information, HARQ-ACKs and/or scheduling requests (SRs) and may be divided into multiple PUCCHs based on the length of the PUCCH transmission.

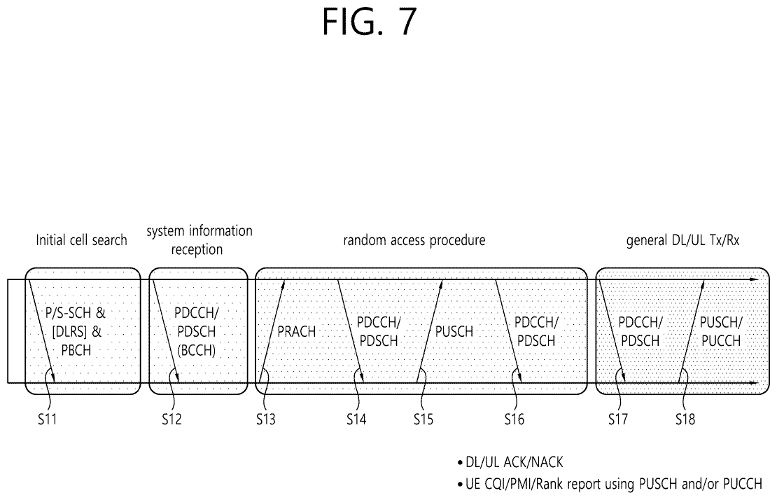

FIG. 8 shows a frame structure in a 3GPP based wireless communication system to which implementations of the present disclosure are applied.

The frame structure shown in FIG. 8 is purely exemplary and the number of subframes, the number of slots, and/or the number of symbols in a frame may be variously changed. In the 3GPP based wireless communication system, OFDM numerologies (e.g., SCS, Transmission Time Interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or Cyclic Prefix (CP)-OFDM symbols), SC-FDMA symbols (or Discrete Fourier Transform-spread-OFDM (DFT-s-OFDM) symbols).

Referring to FIG. 8, downlink and uplink transmissions are organized into frames. Each frame has T_{f}=10 ms duration. Each frame is divided into two half-frames, where each of the half-frames has 5 ms duration. Each half-frame consists of 5 subframes, where the duration T_{sf} per subframe is 1 ms. Each subframe is divided into slots and the number of slots in a subframe depends on a subcarrier spacing. Each slot includes 14 or 12 OFDM symbols based on a CP. In a normal CP, each slot includes 14 OFDM symbols and, in an extended CP, each slot includes 12 OFDM symbols. The numerology is based on exponentially scalable subcarrier spacing Δf=2^{μ}*15 kHz.

Table 3 shows the number of OFDM symbols per slot N^{slot}_{symb}, the number of slots per frame N^{frame, μ}ₛₗₒₜ, and the number of slots per subframe N^{subframe, μ}ₛₗₒₜ for the normal CP, according to the subcarrier spacing Δf=2^{μ}*15 kHz.

TABLE 3

| μ | N^{slot}_{symb} | N^{frame, μ}ₛₗₒₜ | N^{subframe, μ}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 4 shows the number of OFDM symbols per slot N^{slot}_{symb}, the number of slots per frame N^{frame, μ}ₛₗₒₜ, and the number of slots per subframe N^{subframe, μ}ₛₗₒₜ for the extended CP, according to the subcarrier spacing Δf=2^{μ}*15 kHz.

TABLE 4

| μ | N^{slot}_{symb} | N^{frame, μ}ₛₗₒₜ | N^{subframe, μ}ₛₗₒₜ |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N^{size, μ}_{grid,x}*N^{RB}_{sc} subcarriers and N^{subframe, μ}_{symb} OFDM symbols is defined, starting at Common Resource Block (CRB) N^{start, μ}_{grid} indicated by higher-layer signaling (e.g., RRC signaling), where N^{size, μ}_{grid,x} is the number of Resource Blocks (RBs) in the resource grid and the subscript x is DL for downlink and UL for uplink. N^{RB}_{sc} is the number of subcarriers per RB. In the 3GPP based wireless communication system, N^{RB}_{sc} is 12 generally. There is one resource grid for a given antenna port p, subcarrier spacing configuration u, and transmission direction (DL or UL). The carrier bandwidth N^{size, μ}_{grid} for subcarrier spacing configuration μ is given by the higher-layer parameter (e.g., RRC parameter). Each element in the resource grid for the antenna port p and the subcarrier spacing configuration p is referred to as a Resource Element (RE) and one complex symbol may be mapped to each RE. Each RE in the resource grid is uniquely identified by an index k in the frequency domain and an index l representing a symbol location relative to a reference point in the time domain.

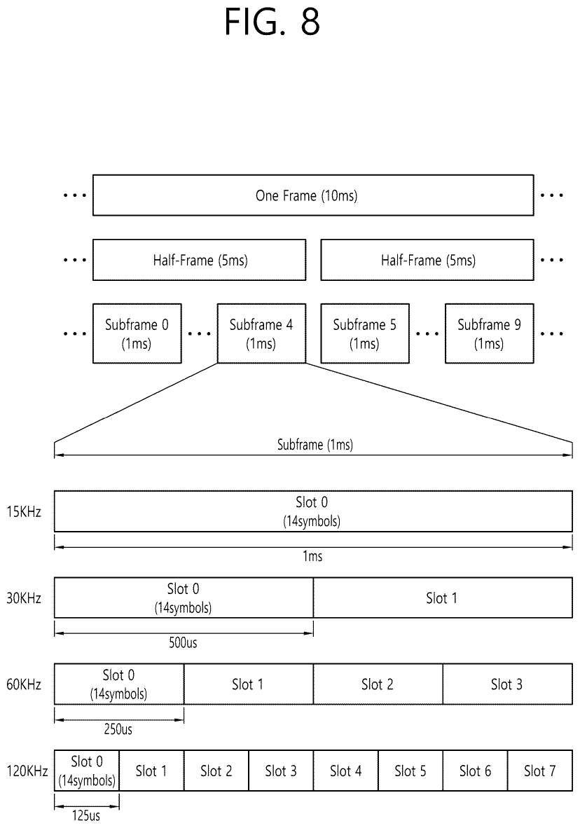

FIG. 9 illustrates a slot structure of a frame, according to one embodiment of the present disclosure.

Referring to FIG. 9, a slot includes a plurality of symbols in the time domain. For example, a slot may include 14 symbols in a normal CP, whereas a slot may include 12 symbols in an extended CP. Or, for a normal CP, a slot may contain seven symbols, whereas for an extended CP, a slot may contain six symbols.

A carrier includes a plurality of subcarriers in the frequency domain. A Resource Block (RB) may be defined as a plurality (e.g., 12) of contiguous subcarriers in the frequency domain. A Bandwidth Part (BWP) may be defined as a plurality of contiguous (P)RBs ((Physical) Resource Blocks) in the frequency domain, which may correspond to one numerology (e.g., SCS, CP length, etc.). A carrier may contain up to N (e.g., 5) BWPs. Data communication may be performed over the active BWPs. Each element may be referred to as a Resource Element (RE) in the resource grid and may be mapped with one complex symbol.

In 3GPP-based wireless communication systems, RB is defined as 12 contiguous subcarriers in the frequency domain. In the 3GPP NR system, RBs are classified into CRBs and Physical Resource Blocks (PRBs). CRBs are numbered from 0 and upwards in the frequency domain for subcarrier spacing configuration p. The center of subcarrier 0 of CRB 0 for subcarrier spacing configuration p coincides with ‘point A’ which serves as a common reference point for resource block grids. In the 3GPP NR system, PRBs are defined within a BandWidth Part (BWP) and numbered from 0 to N^{size}_{BWP,i}−1, where i is the number of the bandwidth part. The relation between the physical resource block n_{PRB} in the bandwidth part i and the common resource block n_{CRB} is as follows: n_{PRB}=n_{CRB}+N^{size}_{BWP,i}, where N^{size}_{BWP,i} is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

In the PHY layer, the uplink transport channels UL-SCH and Random Access Channel (RACH) are mapped to their physical channels Physical Uplink Shared Channel (PUSCH) and Physical Random Access Channel (PRACH), respectively, and the downlink transport channels DL-SCH, BCH and PCH are mapped to Physical Downlink Shared Channel (PDSCH), Physical Broadcast Channel (PBCH) and PDSCH, respectively. In the PHY layer, Uplink Control Information (UCI) is mapped to PUCCH, and Downlink Control Information (DCI) is mapped to Physical Downlink Control Channel (PDCCH). A MAC PDU related to UL-SCH is transmitted by a UE via a PUSCH based on an UL grant, and a MAC PDU related to DL-SCH is transmitted by a BS via a PDSCH based on a DL assignment.

As the amount of data traffic in cellular mobile communication systems has grown rapidly, technologies have been developed to transmit data over unlicensed spectrum bands. Unlicensed spectrum bands are frequency bands that are not licensed for cellular mobile communications, but are shared with other communications systems such as Wi-Fi. To allow multiple wireless access technologies to coexist, unlicensed frequency bands can use a channel access method based on energy detection behavior. LTE Licensed Assisted Access (LTE-LAA) and NR Unlicensed (NR-U) support Listen Before Talk (LBT) technology, which enables frequency sharing between multiple radio access technologies according to Carrier Sensing Multiple Access/Collision Avoidance (CSMA/CA) procedures.

LBT should always be performed before data can be transmitted in unlicensed frequency bands. In the typical transmission method of scheduling one PUSCH with one DCI, the transmission rate of uplink data may be significantly degraded. Therefore, in LTE enhanced LAA (eLAA) and/or NR-U, multiple TTI scheduling may be applied, which allows multiple PUSCHs to be scheduled with one DCI.

Furthermore, as the frequency of the carrier increases, phase noise becomes a major factor that degrades the performance of the communication system. The OFDM system employed by NR can mitigate the performance degradation caused by phase noise by widening the subcarrier spacing. For this reason, NR uses wider subcarrier spacing as the frequency of the carrier increases. For the same number of subcarriers, the wider subcarrier spacing reduces the length of the OFDM symbols and the length of a slot consisting of 14 OFDM symbols. If the UE attempts to receive PDCCH in every slot, the power consumption of the UE will also increase as the slot length decreases.

To address this, it may be proposed that the UE attempts to receive PDCCH in multiple slot cycles instead of every slot. However, by increasing the PDCCH reception interval from every slot to multiple slots, the power consumption of the UE can be prevented from increasing, but the data transmission rate may decrease. Therefore, techniques for scheduling multiple PUSCHs and/or PDSCHs with a single DCI, similar to the multiple TTI scheduling in NR-U, are being standardized.

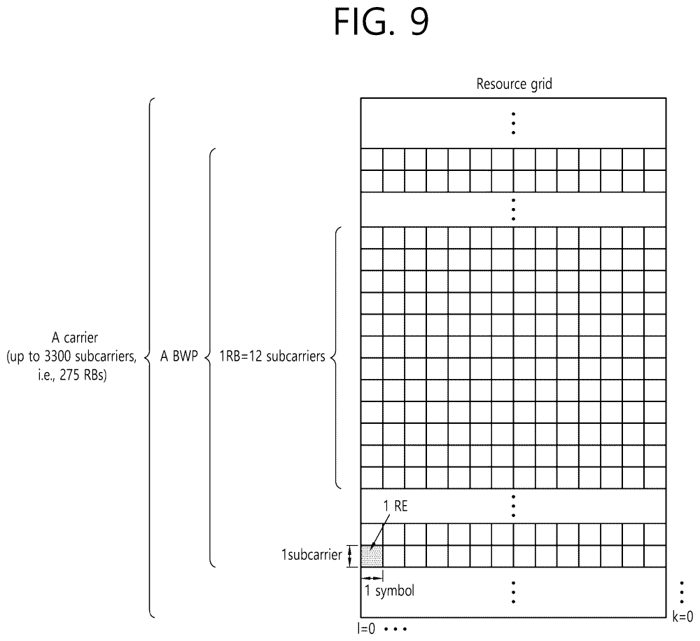

FIG. 10 shows an example of conventional multi-TTI scheduling in which multiple PUSCHs are scheduled with one DCI.

The one DCI to schedule a plurality of PUSCHs and/or multiple TTI scheduling shown in FIG. 10 may be used in NR-U. In addition, multiple TTI scheduling is a technique for reducing power consumption of UEs in frequency bands above 52 GHz, and can be applied to PDSCH scheduling as well as PUSCH.

Referring to FIG. 10, the information delivered in the DCI 800 includes a Time Domain Resource Assignment (TDRA), a Modulation and Coding Scheme (MCS), a plurality of New Data Indicators (NDIs), a plurality of Redundancy Versions (RVs), and a Hybrid Automatic Repeat Request (HARQ) Process Number (PN). The TDRA indicates the index of the TDRA table which comprises time domain resource allocation information such as the number of PUSCHs to be scheduled along with the start symbol and length for each PUSCH, etc. The UE may obtain the number of PUSCHs scheduled by each DCI based on the TDRA. The MCS is applied equally to all PUSCHs. The NDI and RV consist of one bit for each PUSCH and as many bits as the maximum number of PUSCHs that can be scheduled by the TDRA table. HARQ PN is the HARQ process number of the first PUSCH, and the HARQ PN of the second and subsequent PUSCHs has a sequential value from the HARQ PN of the first PUSCH. The information included in the DCI 800 shown in FIG. 10 is illustrative only, and other information may be included, and some of the information described in FIG. 8 may be omitted.

Table 5 shows an example of an MCS index table for PUSCH when the modulation order is 64 Quadrature Amplitude Modulation (QAM).

TABLE 5

| MCS Index | Modulation | Target code Rate | Spectral |
|---|---|---|---|
| I_{MCS} | Order Qₘ | R × 1024 | efficiency |
| 0 | q | 240/q | 0.2344 |
| 1 | q | 314/q | 0.3066 |
| 2 | 2 | 193 | 0.3770 |
| 3 | 2 | 251 | 0.4902 |
| 4 | 2 | 308 | 0.6016 |
| 5 | 2 | 379 | 0.7402 |
| 6 | 2 | 449 | 0.8770 |
| 7 | 2 | 526 | 1.0273 |
| 8 | 2 | 602 | 1.1758 |
| 9 | 2 | 679 | 1.3262 |
| 10 | 4 | 340 | 1.3281 |
| 11 | 4 | 378 | 1.4766 |
| 12 | 4 | 434 | 1.6953 |
| 13 | 4 | 490 | 1.9141 |
| 14 | 4 | 553 | 2.1602 |
| 15 | 4 | 616 | 2.4063 |
| 16 | 4 | 658 | 2.5703 |
| 17 | 6 | 466 | 2.7305 |
| 18 | 6 | 517 | 3.0293 |
| 19 | 6 | 567 | 3.3223 |
| 20 | 6 | 616 | 3.6094 |
| 21 | 6 | 666 | 3.9023 |
| 22 | 6 | 719 | 4.2129 |
| 23 | 6 | 772 | 4.5234 |
| 24 | 6 | 822 | 4.8164 |
| 25 | 6 | 873 | 5.1152 |
| 26 | 6 | 910 | 5.3320 |
| 27 | 6 | 948 | 5.5547 |

| | | |
|---|---|---|
| 28 | q | reserved |
| 29 | 2 | reserved |
| 30 | 4 | reserved |
| 31 | 6 | reserved |

Referring to FIG. 10, the DCI 800 schedules N_{PUSCH} number of PUSCHs starting with HARQ PN K. The first PUSCH, PUSCH #1 810, corresponds to HARQ PN K. The HARQ PNs of the second and subsequent PUSCHs are calculated by a modulo operation from the HARQ PN K. For example, the HARQ PN of the second PUSCH, PUSCH #2 811, is calculated as (K+1) modulo N_{HARQ}, and the HARQ PN of the N_{PUSCH}-th PUSCH, PUSCH #N_{PUSCH} 812, is calculated as (K+N_{PUSCH}−1) modulo N_{HARQ}. N_{HARQ} is the number of HARQ processes in operation.

As described above, in multiple TTI scheduling, where multiple PUSCHs and/or multiple PDSCHs (hereinafter referred to as PUSCHs and PDSCHs collectively as PXSCHs) are scheduled by a single DCI, the same MCS may be applied to all of the multiple PXSCHs. That is, the data transmitted over each PXSCH will have the same physical transmission quality, even though the transmission quality required for the data transmitted over each PXSCH may be different (e.g., Block Error Rate (BLER), latency, etc.).

If multiple PXSCHs scheduled by a single DCI are all subject to the same MCS, it may be difficult to use radio resources efficiently, resulting in inefficient transmission and difficulty in ensuring transmission quality. For example, when transmitting two data streams with different target BLERs, to satisfy both target BLERs, the MCS should be determined based on the lower target BLER, which may result in excessive radio resources being allocated for the logical channel requiring the higher target BLER. Conversely, if the MCS is determined based on a high target BLER, the BLER of logical channels requiring lower target BLER may increase, resulting in transmission delays or, in the worst case, transmission failures. If a transmission failure occurs at the physical layer, it should be recovered by ARQ procedures at higher layers such as RLC, which requires additional radio resources and may significantly increase transmission delay.

To address this, it may be proposed that data streams requiring different QoS are scheduled with different DCIs. In this case, different MCSs are applied to data streams that require different QoS, which allows efficient use of radio resources, but the number of PDCCHs that need to be used increases by the number of data streams. The PDCCH is an additional channel for transmitting the actual data, and the increase in resources used for PDCCH may result in a decrease in overall system capacity. In addition, the number of PDCCHs and PXSCHs that a UE should process at any one time increases, which may increase system complexity and power usage. In particular, this may become an increasingly important issue in the future as the number of services supported simultaneously by a single UE increases and the number of UEs that need to be supported simultaneously in a wireless communication network increases.

Hereinafter, methods and apparatus are described that, in accordance with implementations of the present disclosure, can efficiently transmit multiple QoS data streams by applying different MCSs for each PXSCH while minimizing the increase in DCI size in multiple TTI scheduling where a single DCI schedules a plurality of PXSCHs.

In multiple TTI scheduling, where a single DCI is used to schedule a plurality of PXSCHs, applying a different MCS for each PXSCH to transmit a plurality of logical channels with different QoS may significantly increase the size of the DCI because as many MCSs as the number of PXSCHs being scheduled are required. Therefore, there is a need for a technique that can transmit PXSCHs with different MCSs depending on the required QoS without increasing the size of the DCI.

The lower the MCS of the PXSCH, i.e., the lower order modulation scheme and lower encoding rate used, the lower the BLER. Lower BLER also reduces transmission delay because it increases the probability of successful data transmission with fewer transmissions. Therefore, the higher the desired transmission reliability and the lower the desired transmission latency, the lower the MCS should be used.

The following drawings are created to explain specific embodiments of the present disclosure. The names of the specific devices or the names of the specific signals/messages/fields shown in the drawings are provided by way of example, and thus the technical features of the present disclosure are not limited to the specific names used in the following drawings.

The symbols/abbreviations/terms used in this specification are as follows.

AMC: Adaptive Modulation and Coding, AR: Augmented Reality, ARQ: Automatic Repeat request, BER: Bit Error Rate, BLER: Block Error Rate, CB: Code Block, CBG: Code Block Group, CC: Chase Combining, CE: Control Element, CQI: Channel Quality Indicator, CR: Coding Rate, CRC: Cyclic Redundancy Check, CSI: Channel State Information, DCI: Downlink Control Information, DL: DownLink, DL-SCH: Downlink Shared Channel, HARQ: Hybrid Automatic Repeat request, ID: Identifier, IR: Incremental Redundancy, L1: Layer 1, LCG: Logical Channel Group, LTE: Long-Term Evolution, MAC: Medium Access Control, MCS: Modulation and Coding Scheme, MIMO: Multiple Input Multiple Output, NDI: New Data Indicator, NR: New Radio, PDCCH: Physical Downlink Control Channel, PDSCH: Physical Downlink Shared Channel, PDU: Packet Data Unit, PTB: Primary Transport Block, PUCCH: Physical Uplink Control Channel, PUSCH: Physical Uplink Shared Channel, QoS: Quality of Service, RA: Resource Assignment, RLC: Radio Link Control, RV: Redundancy Version, SDU: Service Data Unit, SINR: Signal to Interference and Noise Ratio, SNS: Social Networking Service, STB: Secondary Transport Block, STI: Sorted Transmission Indicator, TB: Transport Block, TTI: Transmit Time Interval, UL: UpLink, UL-SCH: Uplink Shared Channel, UTI: Unsorted Transmission Indicator, VR: Virtual Reality.

As wireless communication technologies and user devices evolve, there is an increasing need to provide a variety of services requiring different QoS to a single device, or to provide services comprising functions requiring different QoS. An example of the former is when a smartphone user is using social media or browsing the Internet while watching a video. An example of the latter is when AR/VR services require different data rates and latencies for visual and auditory data.

As described above, when providing services related with different QoS, a method of scheduling multiple data channels (e.g., PUSCH, PDSCH) via a single control information (e.g., DCI) may be used.

Specifically, when scheduling multiple data channels (e.g., PUSCH or PDSCH) with a single DCI, a multi-TTI multi-MCS scheduling DCI technique may be used to efficiently transmit multi-QoS data streams, where each PUSCH or PDSCH (hereinafter denoted as PXSCH) is transmitted with a different MCS depending on the QoS of the data being transmitted.

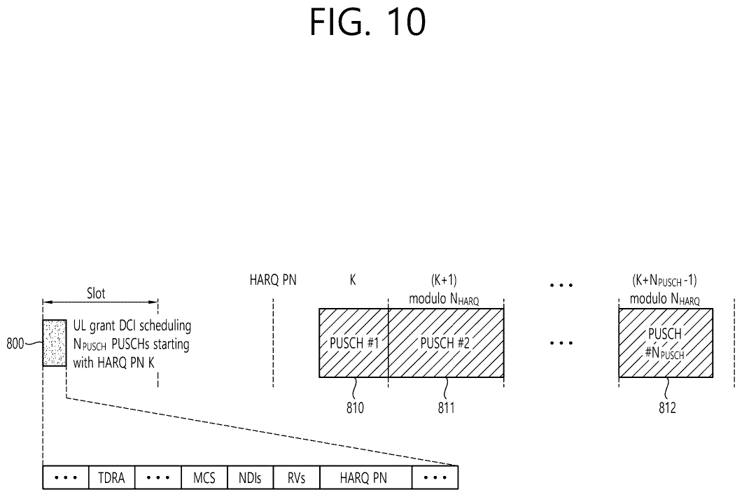

FIG. 11 shows an example of a multi-TTI multi-MCS scheduling DCI.

Referring to FIG. 11, a multi-TTI multi-MCS scheduling DCI may carry a plurality of MCS information with a minimum number of DCI bits. For example, after sorting in ascending order by the target MCS index for each data stream to be transmitted, the reference MCS index (=I_{REF}) and the cumulative MCS index difference (offset, e.g., O₁, O₂, O₃, O₄ in FIG. 11) for each PXSCH are transmitted. The cumulative MCS index difference value may be, for O₁, the target MCS index of PXSCH #1 minus the reference MCS index, and for O₂, O₃, and O₄, the target MCS index of the corresponding PXSCH minus the target MCS index of the PXSCH with the immediately preceding index.

For example, a DCI 1110 may be sent that schedules four PXSCHs starting with HARQ process number (PN) K. The DCI 1110 schedules PXSCH #1 (1120) corresponding to HARQ PN K, PXSCH #2 (1130) corresponding to HARQ PN (K+1) modulo N_{HARQ}, PXSCH #3 (1140) corresponding to HARQ PN (K+2) modulo N_{HARQ}, and PXSCH #4 (1150) corresponding to HARQ PN (K+3) modulo N_{HARQ}.

Depending on the QoS (e.g., transmission reliability, latency, etc.) of the data to be transmitted, the data to be transmitted with the lowest MCS (i.e., corresponding to high transmission reliability and low latency) is mapped to PXSCH #1 (1120), and the data to be transmitted with the highest MCS (i.e., corresponding to low transmission reliability and high latency) is mapped to PXSCH #4 (1150). Thus, the MCS indices of PXSCH #1 (1120), PXSCH #2 (1130), PXSCH #3 (1140), and PXSCH #4 (1150) are arranged in ascending order. The MCS indices of PXSCH #1 (1120), PXSCH #2 (1130), PXSCH #3 (1140), and PXSCH #4 (1150) may be I₁, I₂, I₃, and I₄, respectively (I₁<I₂<I₃<I₄).

If the MCS indices I₁, I₂, I₃, and I₄ of PXSCH #1 (1120), PXSCH #2 (1130), PXSCH #3 (1140), and PXSCH #4 (1150) are included in the DCI as they are, the size of the DCI will be large. To avoid this, the MCS indices I₁, I₂, I₃, and I₄ may be known using the reference MCS index (I_{REF}) and the cumulative MCS index difference values (O₁, O₂, O₃, O₄), as shown in FIG. 11.

For example, the UE may understand the MCS index I₁ of PXSCH #1 (1120) to be I_{REF}+O₁, and the MCS index I₂ of PXSCH #2 (1130) to be I_{REF}+O₁+O₂. Here, O₁ is the MCS index I₁ of PXSCH #1 (1120) minus I_{REF}. O₂ is the MCS index I₂ of PXSCH #2 (1130) minus the MCS index I₁ of PXSCH #1 (1120). Similarly, the MCS index I₃ of PXSCH #3 1140 can be expressed as I_{REF}+O₁+O₂+O₃. O₃ is the MCS index I₃ of PXSCH #3 (1140) minus the MCS index I₂ of PXSCH #2 (1130). The MCS index I₄ of PXSCH #4 (1150) can be represented as I_{REF}+O₁+O₂+O₃+O₄. O₄ is the MCS index I₄ of PXSCH #4 (1150) minus the MCS index I₃ of PXSCH #3 (1140), i.e., the MCS index of each PXSCH can be obtained by adding I_{REF} to the cumulative MCS index difference(s).

Described herein are apparatus and methods for transmitting a plurality of data streams over a plurality of PUSCHs transmitted using different MCSs, when the plurality of PUSCHs transmitted using different MCSs are scheduled via a single DCI.

In cellular mobile communication systems such as 4G LTE and 5G NR, the uplink, where the device transmits data to the base station, the base station provides the device with information such as the radio resources and MCS required to transmit the data. The base station needs to know the size of the data to be transmitted by the UE for radio resource allocation, and the UE provides this information (the size of the data to be transmitted) through the Buffer Status Report (BSR). The QoS requirements for data for a particular service may be predefined or set by the base station to the UE.

However, since the time of BSR, the time when the base station schedules the uplink radio resources, and the time when the UE actually transmits the PUSCH are different, the buffer state (of the UE) used by the base station when scheduling the uplink radio resources and the buffer state (of the UE) when the UE actually transmits the PUSCH may be different. This is not a major problem if the data to be transmitted by the UE is of the same QoS, but it can cause problems if it is not.

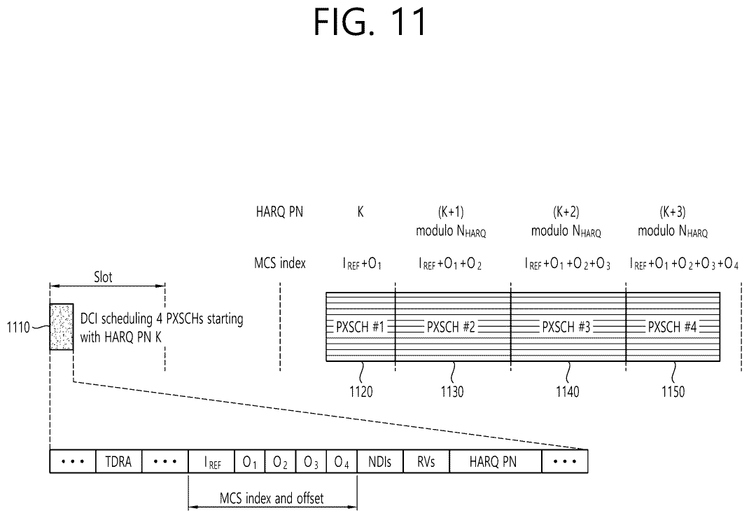

FIG. 12 illustrates a case where the buffer status information used by the base station for scheduling does not match the actual buffer status of the UE.

Referring to FIG. 12, a base station (gNB) and a UE may have two logical channels LCH1 and LCH2 established with different QoS requirements. Suppose the QoS requirement of LCH1 is higher than LCH2, so the MAC of the UE schedules LCH1 in preference to LCH2.

In the UE, the logical channel 2 (LCH2) data may first reach the buffer (S121), and a BSR for this state may be transmitted (S122) to the base station. Here, the buffer status may be represented as (buffer status of LCH1, buffer status of LCH2), where BS₁ refers to the buffer status of LCH1 after the LCH1 data arrives, and BS₂ refers to the buffer status of LCH2 after the LCH2 data arrives. In S121 and S122, LCH1 data has not reached the buffer, so the buffer status is shown as 0, and LCH2 data has reached the buffer, so the buffer status is shown as BS₂.

After the UE transmits the BSR, new data, e.g. LCH1 data, may reach the buffer before the PUSCH scheduling DCI is received (S123). In this case, the buffer state will be (BS₁, BS₂).

After receiving the BSR, the base station transmits the uplink grant DCI for LCH2 data transmission to the UE (S124), i.e., schedules a PUSCH for LCH2 data transmission. At this time, the MCS of the PUSCH is determined by the target BLER of LCH2.

The UE that receives the above uplink grant DCI shall transmit the LCH1 data first via the above PUSCH (S125) because there is data (LCH1 data) in the LCH1 buffer with a higher priority. If the target BLER of LCH1 is lower than the target BLER of LCH2 (i.e., if the QoS requirement of LCH1 is higher than that of LCH2), the transmission may be performed with the LCH1 transmission quality lower than the target value.

In other words, new data may enter the buffer after the UE transmits the BSR but before it receives the PUSCH scheduling DCI, resulting in a mismatch between the buffer state information used by the base station for scheduling and the actual buffer state of the UE, resulting in data transmission over PUSCH scheduled with inadequate transmission quality.

To improve this problem, the PUSCH can be given two levels of priority, 0 (=p0) and 1 (=p1), with p1 being the higher priority, and the priority of the PUSCH that can be transmitted for each logical channel can be specified. P0, P1 are referred to as priority index information.

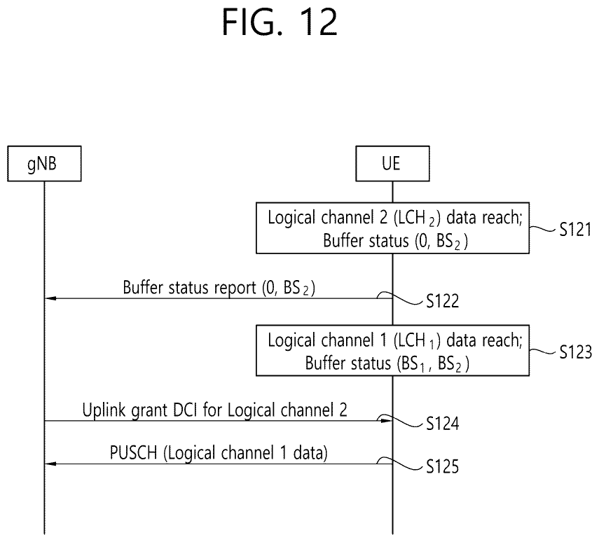

FIG. 13 shows an example of improving transmission quality degradation due to buffer status inconsistency using priority index information.

Two logical channels LCH1 and LCH2 with different QoS requirements may be configured for the base station and the UE. Assume that the QoS requirement of LCH1 is higher than that of LCH2, so the UE's MAC schedules LCH1 with priority over LCH2.

Referring to FIG. 13, the base station may provide logical channel configuration to the UE through a higher layer signal (e.g., RRC message) (S131).

The logical channel configuration can be set to the UE, for example, to transmit logical channel 1 (LCH1) data only on the PUSCH of priority 1 (p1).

In the UE, the logical channel 2 (LCH2) data first reaches the buffer (S132) and the BSR (0, BS₂) for this state can be transmitted to the base station (S133).

After the UE transmits the BSR, new data, e.g. LCH1 data, may reach the buffer before the PUSCH scheduling DCI is received (S134). In this case, the buffer state will be (BS₁, BS₂).

The base station may provide the UE with an uplink grant DCI for logical channel 2 (S135), i.e., the base station may provide the UE with an uplink grant DCI that, based on BSR (0, BS₂) above, sets the MCS of the PUSCH to the target BLER of LCH2 and schedules the priority of the PUSCH to 0 (p0).

After receiving the uplink grant DCI, the MAC of the UE may attempt to transmit the LCH1 data via the PUSCH first because there is data (LCH1 data) in the LCH1 buffer with a higher priority. However, due to the above logical channel configuration that sets the LCH1 data to be transmitted only on the PUSCH of priority 1 (p1), the LCH1 data cannot be transmitted via the PUSCH of priority 0 (p0), and therefore the LCH2 data is transmitted via the PUSCH of priority 0 (p0) (S136).

In multi-TTI multi-MCS transmission, where multiple PUSCHs are scheduled to be sent using different MCSs over a single DCI, transmission degradation due to buffer state mismatches can take a more complex form.

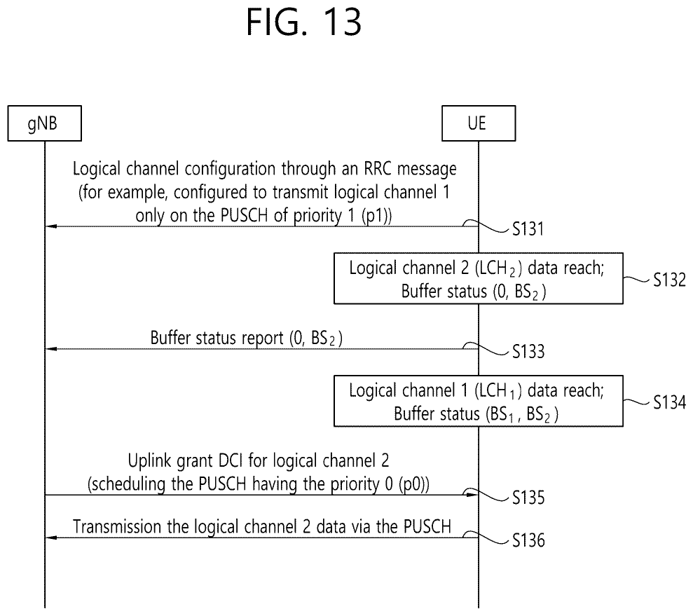

FIG. 14 shows an example of a case where transmission quality is degraded due to buffer status mismatch in multi-TTI multi-MCS transmission.

Referring to FIG. 14, when three logical channels with different QoS requirements (e.g., LCH1, LCH2, and LCH3) are transmitted by a multi-TTI multi-MCS, transmission quality degradation may occur due to buffer state mismatch. Assume that among the above logical channels, LCH1 has the highest QoS requirement and LCH3 has the lowest QoS requirement.

The base station may provide a logical channel configuration to the UE (S141). The logical channel configuration may be, for example, that LCH1 has the highest priority, followed by LCH2 with the highest priority, and finally LCH3 with the lowest priority.

To the UE, logical channel 1 (LCH1) data, logical channel 2 (LCH2) data, and logical channel 3 (LCH3) data may arrive at each buffer (S142). In this case, the buffer status can be represented by (BS₁, BS₂, BS₃).

Suppose the UE transmits a BSR to the base station (S143) with the buffer states of the three logical channels being BS₁, BS₂, and BS₃ respectively, and then additional data on logical channel 1 (LCH1) arrives and updates the buffer state of LCH1 to BS₁₋₁, i.e., the UE's buffer state becomes (BS₁₋₁, BS₂, BS₃).

The base station schedules the plurality of PUSCHs according to the QoS information and the above BSR information (S145), i.e., the base station determines from the buffer information and the target BLER for each logical channel the MCS of the PUSCHs to be transmitted by each logical channel and allocates radio resources. In general, high QoS requires a low target BLER, so it is reasonable to transmit with a low MCS.

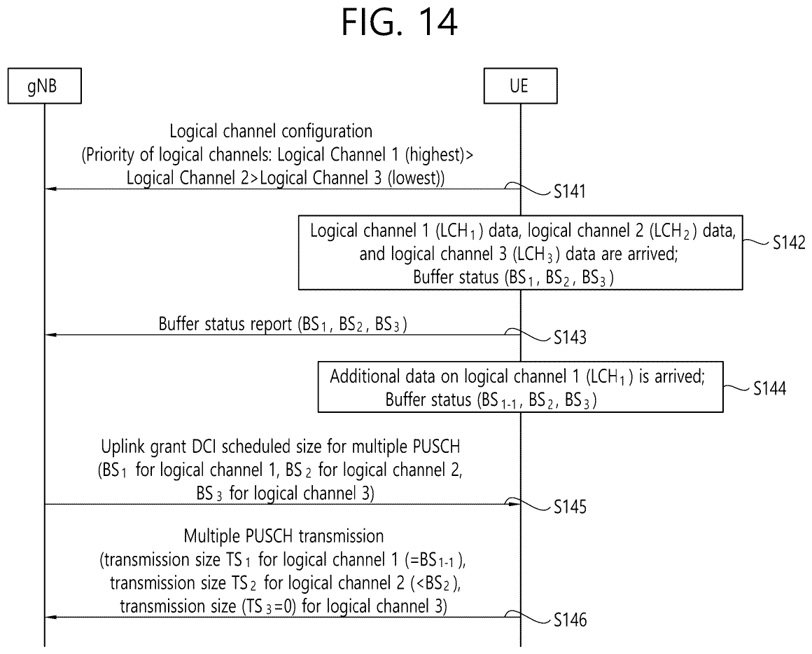

The UE receiving the DCI transmits data through PUSCH (S146). At this time, a discrepancy between the transmission expected by the base station's scheduling and the actual transmission by the UE may occur, as shown in FIG. 15.

FIG. 15 shows an example where there is a discrepancy between transmission expected by the base station's scheduling and actual transmission by the UE.

Referring to FIG. 15, assume, for example, that the (logical channel) MCS index of LCH1 is determined to be 10, the (logical channel) MCS index of LCH2 is determined to be 12, and the (logical channel) MCS index of LCH3 is determined to be 15. The (logical channel) MCS index means the MCS index determined for the logical channel. Suppose the (physical channel) MCS indexes of the PUSCHs are determined to be 10 for PUSCH #1 and 2, 12 for PUSCH #3, and 15 for PUSCH #4. The (physical channel) MCS index means the MCS index determined for the physical channel. Both the (Logical Channel) MCS Index and the (Physical Channel) MCS Index can be referred to simply as MCS Index. PUSCHs can be scheduled in ascending order by the (physical channel) MCS index.

Based on the QoS information and buffer status information, the base station may schedule the UE to transmit, for example, LCH1 to PUSCH #1 and #2, LCH2 to PUSCH #3, and LCH3 to PUSCH #4. However, since the allocation of radio resources and the size of the data may not exactly match, some LCH2 data may be scheduled to be transmitted on PUSCH #2 and some LCH3 data on PUSCH #3, as shown in FIG. 15, ‘Scheduling by the base station’. In this case, since the data with the higher target BLER (lower QoS) is scheduled to be transmitted over the PUSCH with the lower target BLER (higher QoS), there is no degradation in transmission quality when transmitted according to this scheduling.

At step S146 of FIG. 14, the MAC of the UE schedules LCH1 first, followed by LCH2, LCH3, and so on according to the priority. At this time, because the data in LCH1 has increased (S144), it may occur that some LCH1 data is transmitted on PUSCH #3 and some LCH2 data is transmitted on PUSCH #4, as shown in ‘Transmission by the UE’ in FIG. 15, contrary to the intention of the base station. In this case, data with a lower target BLER is transmitted on a PUSCH with a higher target BLER, which may result in degraded transmission quality.

To solve this problem, each logical channel and PUSCH can be assigned priority information (priority index information), but the problem is that the size of the DCI increases as the number of logical channels with different priorities and PUSCHs scheduled in one DCI increases.

In addition, even if buffer state inconsistencies do not occur, conventional prioritised bit rate (PBR)-based scheduling can cause transmission quality degradation when applied to multiple PUSCH multiple MCS transmissions. PBR-based scheduling is a scheduling method in which data is scheduled to satisfy the PBR for all logical channels first, and the remaining radio resources are given the opportunity to be used sequentially, starting with the highest priority logical channel.

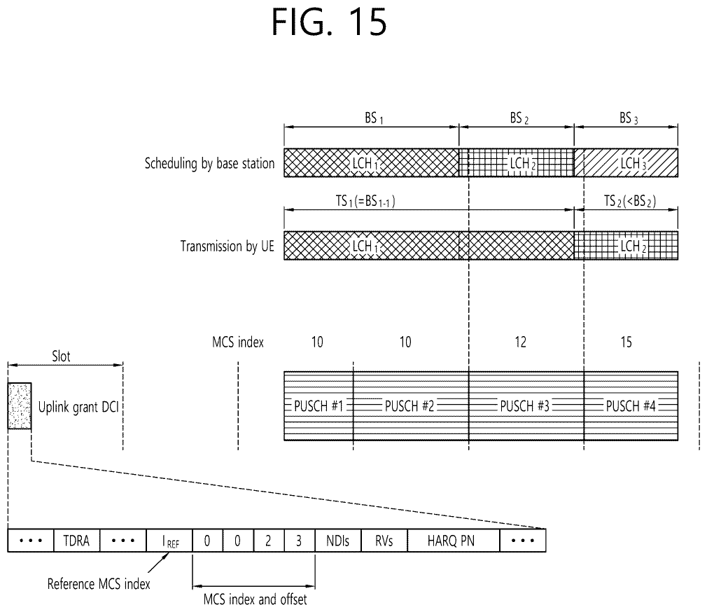

FIG. 16 illustrates a case where quality degradation occurs when applying conventional PBR-based scheduling in multi-TTI multi-MCS transmission.

Referring to FIG. 16, assume that the MCS index of LCH1 is determined to be 10, the MCS index of LCH2 is determined to be 12, and the MCS index of LCH3 is determined to be 15. Assume that the MCS indexes of the PUSCHs are determined to be 10 for PUSCH #1 and 2, 12 for PUSCH #3, and 15 for PUSCH #4. In this case, as shown in ‘Scheduling by the base station’, the base station can schedule the UEs to transmit to PUSCHs #1 and #2 for LCH1, PUSCHs #2 and 3 for LCH2, and PUSCHs #3 and 4 for LCH3 according to the QoS information and buffer status information.

The UE may first schedule enough data to satisfy the PBRs of LCH1, LCH2, and LCH3 (in FIG. 16, B1, B2, and B3 are the sizes of data prioritised for scheduling to satisfy the PBRs of each logical channel) and schedule the highest priority LCH1 on the remaining resources 161, as shown in ‘Transmission by the UE (PBR-based scheduling)’.

In this case, LCH1 is sent to PUSCH #4 at MCS 15, even though it should be sent at MCS 10 to meet the target BLER, which can cause transmission quality degradation issues.

Both of the aforementioned problems arise because the logical channel data is transmitted to a PUSCH using an MCS that cannot satisfy the target BLER (or QoS) required by the logical channel. There is a need for a method and apparatus that minimises the increase in size of the DCI while ensuring that each logical channel is only sent on a PUSCH using an MCS that can satisfy the target BLER.

The present disclosure provides a technique for transmitting a plurality of logical channel data over a PUSCH that will transmit new data (i.e., not a PUSCH that retransmits data) while satisfying the transmission quality when scheduling a plurality of PUSCHs with a single DCI. It is assumed that the higher the priority of the logical channels, the lower the target BLER required.

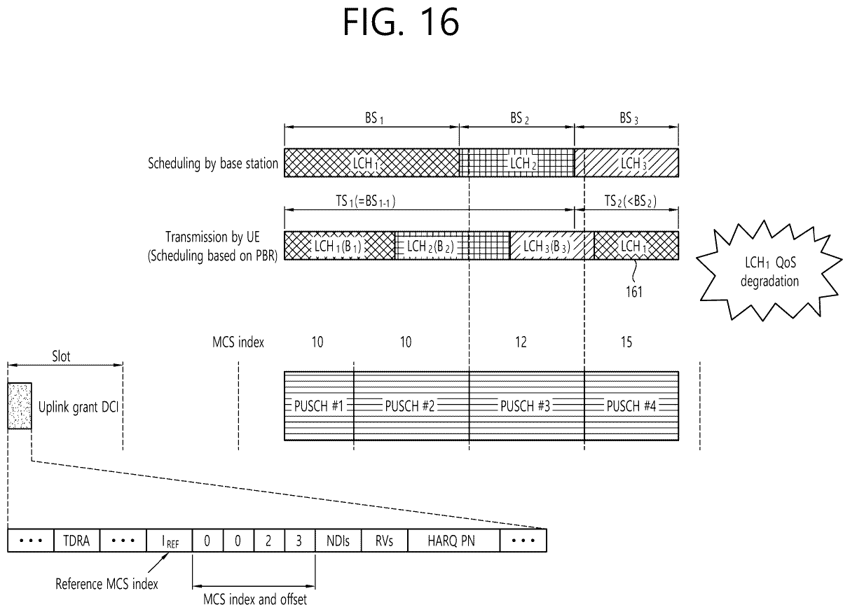

FIG. 17 illustrates a physical uplink shared channel (PUSCH) transmission method of a UE in a wireless communication system according to one embodiment of the present disclosure.

Referring to FIG. 17, the UE receives a logical channel MCS related value for each of the plurality of logical channels via a higher layer signal (e.g., an RRC message or a medium access control (MAC) control element (CE)) (S1710). The logical channel MCS related values may be given as MCS related values, but may also be given based on a corresponding target block error ratio (BLER) or spectral efficiency. For example, an initial configuration of the logical channel MCS related value for each of the plurality of logical channels may be received via an RRC message, and a change configuration of the logical channel MCS-related value may be received via a medium access control (MAC) control element (CE).

The logical channel MCS related value for each of the plurality of logical channels may include at least one of a difference value of the MCS index of each logical channel relative to a reference logical channel (e.g., LCH1) and a spectral efficiency multiplier.

The UE receives one DCI related with scheduling a plurality of PUSCHs (S1720). The DCI may be referred to as a ‘multi-PUSCH UL grant DCI’ in that it is a DCI for scheduling a plurality of PUSCHs, or a ‘multi-TTI multi-MCS scheduling DCI’ in that it provides MCS values for each of the plurality of PUSCHs. The DCI may include information informing a transmission reference logical channel transmitted through a PUSCH with the smallest physical channel MCS value among the plurality of PUSCHs.

The DCI may inform the physical channel MCS value of each of the plurality of PUSCHs through reference MCS index and MCS index offset values.

The DCI may further comprise a sequence number. Among the configuration information including a logical channel MCS related value for each of the plurality of logical channels received via the RRC message or MAC CE, an MCS index difference value or a spectral efficiency multiplier of the configuration information matching the sequence number may be used to determine the logical channel to be transmitted over the plurality of PUSCHs.

For example, the plurality of configuration information including logical channel MCS related values for each of the plurality of logical channels may be referred to as configuration information #1, configuration information #2, . . . , configuration information #N, where each configuration information may include a sequential number distinguishable from the other. Among the plurality of configuration information, the UE may use the logical channel MCS related value for each of the plurality of logical channels included in the configuration information that corresponds to or matches the sequence number included in the DCI.

Alternatively, if the plurality of configuration information is provided in the form of a list, the order in the list may correspond in turn to the sequential number of the DCI, i.e., even if each of the plurality of configuration information does not have an explicit sequential number, if they are distinguishable from each other, logical channel MCS values of logical channels can be identified using configuration information that matches or corresponds to the DCI sequence number.

Based on the higher layer signal and the DCI, the UE transmits the plurality of logical channels (data on the logical channels) via the plurality of PUSCHs (S1730). In this case, a physical channel MCS value for each of the plurality of PUSCHs is determined based on the DCI. Each of the plurality of logical channels is transmitted only via a PUSCH having a physical channel MCS value that does not exceed its logical channel MCS value.

In accordance with an implementation example, the UE obtains a logical channel MCS value for each of the plurality of logical channels via a higher layer signal. The UE obtains a physical channel MCS value for each of the plurality of PUSCHs based on the DCI, and then, based on the physical channel MCS value and the logical channel MCS value, determines a number of PUSCHs and a maximum transmittable size (Aᵢ) that can satisfy a target BLER on each of the plurality of logical channels, and determines a size (TS_{i,1}) that should be transmitted to satisfy a prioritised bit rate (PBR) within the maximum available size for each logical channel according to a priority of each of the plurality of logical channels. Determine the maximum size (TS_{i,2}) that can be transmitted while satisfying the target BLER within the remaining transmission resources for each of the logical channels according to the priority of each of the logical channels, and transmit data of the size of the TS_{i,1} plus TS_{i,2} for each of the logical channels according to the priority of each of the logical channels.

Hereinafter, MCS for a physical channel may refer to the physical channel MCS described above, and MCS for a logical channel may refer to the logical channel MCS described above.

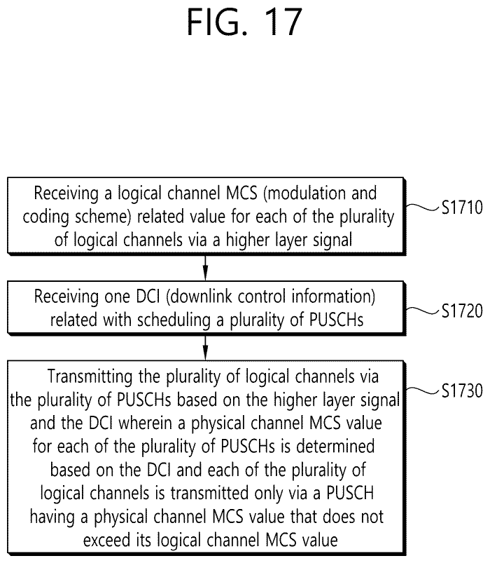

FIG. 18 illustrates the signaling process between the base station and the UE according to the method of FIG. 17.

Referring to FIG. 18, the base station may provide a logical channel configuration to the UE via a higher layer signal (S181). The logical channel configuration may include values related with a logical channel modulation and coding scheme (MCS) for each of the plurality of logical channels.

The UE transmits a buffer status report (BSR) to the base station (S182).

Based on the BSR, the base station transmits a DCI (multi-PUSCH UL grant DCI) for scheduling multiple PUSCHs to the UE (S183). The physical channel MCS value for each of the plurality of PUSCHs is determined based on the DCI.

Based on the higher layer signal and the DCI, the UE transmits each of the plurality of logical channels only through PUSCH having a physical channel MCS value that does not exceed the corresponding logical channel MCS value (S184).

In terms of the base station, it transmits a logical channel MCS related value for each of the plurality of logical channels to a UE via a higher layer signal (S181), and after receiving a BSR from the UE (S182), it transmits one DCI related to scheduling of the plurality of PUSCHs to the UE (S183), and receives the plurality of logical channels via the plurality of PUSCHs (S184). In this process, a physical channel MCS value for each of the plurality of PUSCHs is determined based on the DCI, and each of the plurality of logical channels is received only through a PUSCH having a physical channel MCS value that does not exceed its logical channel MCS value.

Below, the method illustrated in FIGS. 17 and 18 will be described in detail.

The difference in target BLER for each logical channel can be approximated and corresponded to the difference in MCS to be transmitted. The difference in MCS can again be approximated as a multiple of the spectral efficiency.

The logical channel that has (requires) the lowest target BLER among the plurality of logical channels can be referred to as the reference logical channel. The maximum MCS index that satisfies the target BLER of each logical channel other than the reference logical channel can be approximated as the MCS index of the reference logical channel plus an MCS index offset corresponding to the difference between the target BLERs of the two logical channels (the reference logical channel and the corresponding logical channel). Generalising to spectral efficiency, the maximum spectral efficiency that satisfies the target BLER of each logical channel can be approximated as the spectral efficiency of the reference logical channel multiplied by a spectral efficiency multiplier that corresponds to the difference between the target BLERs of the two logical channels.

The base station may provide the UE with a logical channel configuration that includes an MCS index difference or spectral efficiency multiplier for each logical channel relative to a set reference logical channel (hereinafter referred to as the set reference channel). When the base station informs the UE of the logical channel that it expects to be transmitted in the PUSCH with the lowest MCS (hereinafter referred to as the transmission reference channel) through a DCI that schedules a plurality of PUSCHs, the UE may use the relative relationship of the MCS index difference or spectral efficiency multiplier between the logical channels to determine the logical channels to be transmitted in each PUSCH to satisfy the target BLER of each logical channel. The set reference channel and the transmission reference channel may be the same or different.

Table 6 below shows examples of MCS index difference values and spectral efficiency multipliers based on target BLER between multiple logical channels.

TABLE 6

| | | | Spectral efficiency |
|---|---|---|---|
| | | MCS index difference | multiplier from set |
| Logical | Target | from the set reference | reference channel |
| channel | BLER | channel (LCH₁) | (LCH₁) |
| LCH₁ | 10⁻⁴ | 0 | 1.00 |
| LCH₂ | 10⁻³ | 1 | 1.12 |
| LCH₃ | 10⁻¹ | 3 | 1.45 |

Table 6 shows the target BLER for logical channels LCH1, LCH2, and LCH3, the MCS index difference from the set reference channel and the spectral efficiency multiplier required to meet the target BLER sorted in ascending order by target BLER.

In Table 6, the set reference channel is LCH1 with the lowest target BLER. The maximum MCS index and spectral efficiency that can satisfy the target BLER of LCH2 and LCH3 can be expressed as relative values based on the maximum MCS index and spectral efficiency that can satisfy the target BLER of LCH1.

With the base station and the UE sharing the MCS index difference or spectral efficiency multiplier in Table 6, the base station informs the UE via DCI of the logical channel(s) with the lowest target BLER, i.e., the transmission reference channel(s), that it expects to be transmitted in the PUSCH with the smallest MCS index or spectral efficiency among the plurality of scheduled PUSCHs (hereinafter referred to as the reference PUSCH). The UE can ensure the transmission quality by finding the maximum MCS index or spectral efficiency at which each logical channel can be transmitted based on the MCS index or spectral efficiency of the reference PUSCH and transmitting each logical channel only through PUSCHs that can satisfy the target BLER.

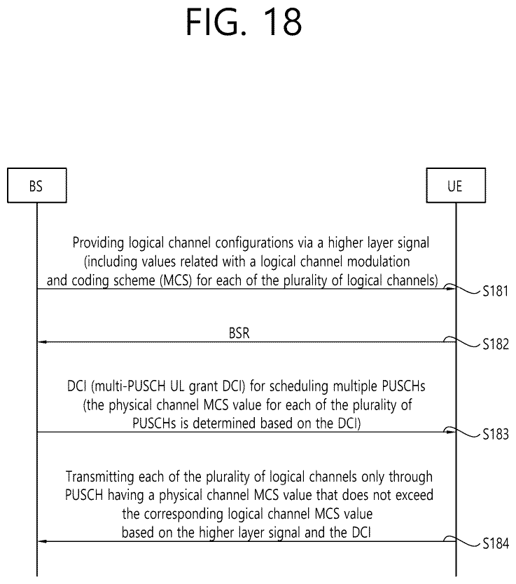

FIG. 19 is an example of determining the transmittable PUSCH(s) for each logical channel.

For example, the UE can determine the PUSCH that can be transmitted for each logical channel based on Table 6 and the transmission reference channel transmitted through DCI.

In the example of FIG. 19, the MCS indices of the four PUSCHs (PUSCH #1 to PUSCH #4) are calculated to be 10, 10, 11, and 13, respectively, based on the reference MCS index of the DCI (I_{REF}=10) and the MCS index offset of each PUSCH. The spectral efficiency calculated by the time and frequency resources allocated to each PUSCH and MCS are assumed to be 1.33, 1.33, 1.48, and 1.91. The field indicating the transmission reference channel is called LCH_{TX-REF}, and LCH_{TX-REF} can inform LCH1.

The UE may determine the range of PUSCHs to which the remaining logical channels may be transmitted based on the transmission reference channel, LCH1, being transmitted to PUSCH #1, which is the first PUSCH among the PUSCHs (PUSCH #1, #2) with the smallest MCS index.

For example, if the UE is given the MCS index difference values for each logical channel in Table 6, the maximum MCS index at which LCH2 and LCH3 can be transmitted is calculated to be 11 and 13, respectively. Therefore, the UE can identify that LCH2 can be transmitted up to PUSCH #3 and LCH3 can be transmitted up to PUSCH #4.

If the UE is given, for example, the spectral efficiency multiplier for each logical channel in Table 6, it can calculate the maximum spectral efficiency at which each logical channel can be transmitted by multiplying the spectral efficiency of PUSCH #1 on which LCH1 is to be transmitted by the spectral efficiency multiplier for each logical channel. Accordingly, the maximum spectral efficiency of LCH2 and LCH3 is calculated to be 1.4896 and 1.9285, respectively. The spectral efficiency of the PUSCH should be less than or equal to the maximum spectral efficiency of the logical channel to achieve the target BLER. Therefore, the UE can identify that LCH2 can transmit up to PUSCH #3 and LCH3 can transmit up to PUSCH #4.

The generalization of the above is as follows.

When N_{LCH} logical channels are open between the base station and the UE and each logical channel is called LCHᵢ (i=1, 2, . . . , N_{LCH}), if the MCS index of the first PUSCH to transmit the transmission reference channel is I_{TX-REF-PUSCH}, MCS index difference value of the transmission reference channel is TO_{TX-REF}, and the MCS index difference value of the i-th logical channel is TOᵢ when the set reference channel is the first logical channel, the maximum MCS index TIᵢ that can transmit the i-th logical channel can be obtained as shown in Equation 1 below.

$${TI}_{i} = {I}_{TX - REF - PUSCH} + {TO}_{i} - {TO}_{TX - REF} \qquad [ Equation l ]$$

The UE can transmit the i-th logical channel only through the PUSCH whose MCS index is less than or equal to TIᵢ, or can be interpreted as such.

When N_{LCH} logical channels are open between the base station and the UE, and each logical channel is called LCHᵢ (i=1, 2, . . . , N_{LCH}), if the spectral efficiency of the first PUSCH to transmit the transmission reference channel is SE_{TX-REF-PUSCH}, the spectral efficiency multiplier of the transmission reference channel is α_{TX-REF}, and the spectral efficiency multiplier of the i-th logical channel is αᵢ when the set reference channel is the first logical channel, the maximum spectral efficiency TSEᵢ that can transmit the i-th logical channel can be obtained as shown in Equation 2 below.

TSEᵢ=SE_{TX-REF-PUSCH}×αᵢ÷α_{TX-REF} [Equation 2]

The UE can transmit the i-th logical channel only through PUSCH, which has a spectral efficiency less than or equal to TSEᵢ, or can be interpreted as such.

As shown in FIG. 19, a DCI that schedules a plurality of PUSCHs may include information indicating the transmission reference channel (LCH_{TX-REF}, hereinafter referred to as transmission reference channel information). The transmission reference channel information may be a Logical Channel Identifier (LCID). However, if a LCID is used as is, the size of the DCI may become unnecessarily large if the number of possible LCIDs is significantly larger than the number of logical channels actually open between the base station and the UE. In such cases, to reduce the size of the DCI, the open logical channels can be passed as the index of a list sorted in ascending order of the MCS index difference value or spectral efficiency multiplier. For example, if three logical channels are open as shown in Table 6, LCH1 can be referred to as 0, LCH2 as 1, and LCH3 as 2.

Meanwhile, since the slope of the BLER curve may vary depending on the channel state, the MCS index difference value or spectral efficiency multiplier between logical channels according to the target BLER may vary.

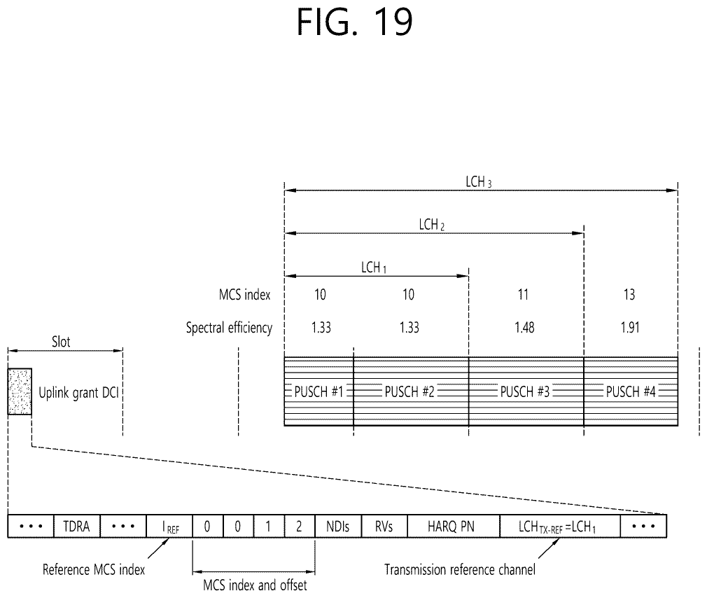

FIG. 20 illustrates a procedure for updating logical channel configurations according to channel state changes.

Referring to FIG. 20, the base station may provide the logical channel configurations (which may include, for example, an MCS index difference value or a spectral efficiency multiplier between the logical channels) to the UE, for example, via an RRC message (S201). The logical channel configurations may include information about the priority of each logical channel. For example, LCH1 may be set to have the highest priority, followed by LCH2, and finally LCH3 may have the lowest priority. In addition, the base station may provide MCS index offset information (MIOI) #1 or spectral efficiency scaling information (SESI) #1 via logical channel configurations.

Data of logical channels 1, 2 and 3 can arrive in the UE's buffer (S202).

The UE transmits a scheduling request (SR) to the base station (S203). Upon receiving the SR, the base station transmits the uplink grant DCI for the BSR to the UE (S204), and based on the uplink grant DCI for the BSR, the UE transmits a BSR to the base station (S205).

The base station transmits the uplink grant DCI for multiple PUSCH transmissions based on the BSR to the UE (S206).

The UE may perform scheduling based on MIOI #1 or SESI #1 (S207).

The UE transmits a plurality of PUSCHs (S208). The UE transmits the i-th logical channel only with a PUSCH whose MCS index or spectral efficiency is less than or equal to TIᵢ or TSEᵢ considering the MCS index or spectral efficiency of the logical channel determined based on the initial logical channel configurations (MIOI #1 or SESI #1) and the MCS index or spectral efficiency of the physical channel determined based on the DCI.

The base station transmits the uplink grant DCI for multiple PUSCH transmissions to the UE (S209).

The UE may perform scheduling based on MIOI #1 or SESI #1 (S210).

The UE transmits a plurality of PUSCHs (S211). Similarly, it transmits the i-th logical channel only through a PUSCH that is less than or equal to the TIᵢ or TSEᵢ described above.

The base station may detect/recognise a change in the uplink channel state (S212).

The base station transmits MIOI #2 or SESI #2 to the UE through MAC CE (S213).

The base station transmits an uplink grant DCI for multiple PUSCH transmissions to the UE (S214). The UE can perform scheduling based on MIOI #2 or SESI #2 (S215). The UE transmits multiple PUSCHs (S216). The UE shall transmit the i-th logical channel only through a PUSCH that is less than or equal to TIᵢ or TSEᵢ as described above (Equations 1 or 2), taking into account the MCS index or spectral efficiency of the logical channel determined based on MIOI #2 or SESI #2 and the MCS index or spectral efficiency of the physical channel determined based on DCI.

As shown above, the base station can quickly adapt to channel changes by transmitting the initial logical channel configuration through an RRC message and later transmitting the changed logical channel configuration through MAC CE.

A sequence number of 1 bit or more can be used to synchronize the MCS index difference value or spectral efficiency multiplier information transmitted in the RRC message or downlink MAC CE with the DCI that schedules multiple PUSCHs. For example, the UE may use the MCS index difference value or spectral efficiency multiplier information contained in the configuration information that matches or corresponds to the sequence number of the DCI to schedule the logical channels to be transmitted with the plurality of PUSCHs.

For example, a plurality of configuration information, including MCS index difference values or spectral efficiency multiplier information for each of a plurality of logical channels, referred to as configuration information #1, configuration information #2, . . . , configuration information #N, each of the configuration information may include a sequential number distinguishable from each other, or may be distinguishable from each other without a sequential number. Among the above plurality of configuration information, the UE may use the MCS index difference value or spectral efficiency multiplier information contained in the configuration information corresponding to or matching the sequential number contained in the DCI.

Once the transmittable PUSCH per logical channel is determined, the UE can apply PBR-based scheduling based on this.

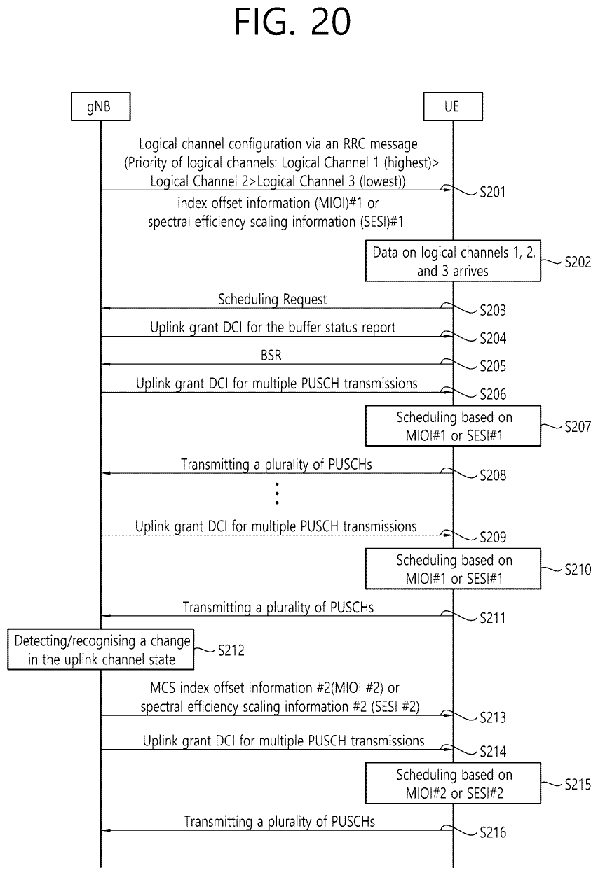

FIG. 21 illustrates the maximum data size that can be transmitted for each logical channel.

Referring to FIG. 21, the UE determines the maximum amount of data that can be transmitted over the scheduled PUSCHs per logical channel. The maximum data size that can be transmitted may be the sum of the Transport Block Sizes (TBS) of the transmittable PUSCHs. When the number of logical channels is N_{LCH} and the number of PUSCHs is N_{PUSCH}, the maximum data size Aᵢ that can transmit the i-th (i=1, 2, . . . , N_{LCH}) logical channel can be obtained as shown in Equation 3 below.

$${A}_{i} = {\sum }_{j = 1}^{{N}_{PUSCH , i}} T B {S}_{j} \qquad [ Equation 3 ]$$

In Equation 3, N_{PUSCH,i} is the number of PUSCHs that can transmit logical channel i while satisfying the target BLER, and TBSⱼ is the TBS of the jth PUSCH.

In the example of FIG. 21, N_{PUSCH,1} is 2, N_{PUSCH,2} is 3, and N_{PUSCH,3} is 4.

After determining the maximum data size that can transmit each logical channel, the UE determines the size of data that should be transmitted preferentially to satisfy the PBR. If the total data size of the ith logical channel in the buffer is BSᵢ, and the data size of the ith logical channel that needs to be transmitted first to satisfy PBR is Bᵢ, then the data size of the ith logical channel that needs to be transmitted first, TS_{i,1}, is given by Equation 4 below.

$$for i = 1 to {N}_{LCH} , \qquad [ Equation 4 ]$$

$$T {S}_{i , 1} = min ( B {S}_{i} , {B}_{i} , {A}_{i} - {\sum }_{j = 1}^{i - 1} T {S}_{j , 1} )$$

If radio resources remain even after scheduling all data to be transmitted preferentially to satisfy PBR, depending on the priorities of the logical channels, the size of data that can be additionally transmitted within the transmittable MCS index or spectral efficiency is calculated. The data size TS_{i,2} of the ith logical channel to be additionally transmitted can be obtained using equations 5 and 6 below.

$${A}_{t o t a l} = {\sum }_{j = 1}^{{N}_{PUSCH}} T B {S}_{j} \qquad [ Equation 5 ]$$

$$for i = 1 to {N}_{LCH} , \qquad [ Equation 6 ]$$

$$T {S}_{i , 2} = min ( B {S}_{i} - T {S}_{i , 1} , {A}_{i} - ( {\sum }_{j = 1}^{i} {TS}_{j , 1} + {\sum }_{j = 1}^{i - 1} T {S}_{j , 2} ) , {A}_{t o t a l} -$$

$$( {\sum }_{j = 1}^{{N}_{L C H}} T {S}_{j , 1} + {\sum }_{j = 1}^{i - 1} T {S}_{j , 2} ) )$$

TSᵢ, the size of data to be transmitted for each logical channel, is the sum of TS_{i,1} and TS_{i,2} as shown in Equation 7 below.

$$T {S}_{i} = T {S}_{i , 1} + T {S}_{i , 2} \qquad [ Equation 7 ]$$

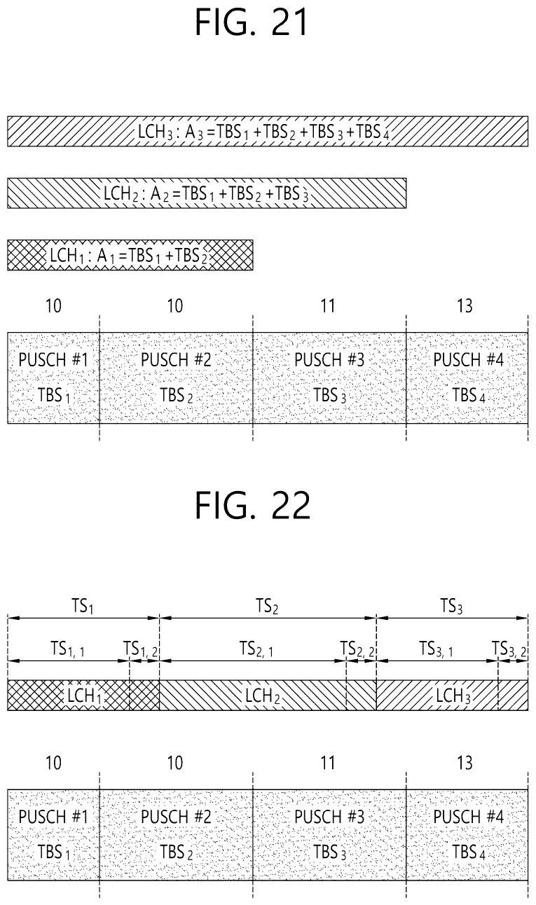

FIG. 22 shows an example in which a UE transmits a logical channel through a plurality of PUSCHs according to priority.

Assume that LCH1 has the highest priority, followed by LCH2, and finally LCH3 has the lowest priority. For example, the logical channel MCS index of LCH1 could be 10, the logical channel MCS index of LCH2 could be 11, and the logical channel MCS index of LCH3 could be 13.

Referring to FIG. 22, the transmit block size (TBS) of PUSCH #1 may be TBS₁, the transmit block size of PUSCH #2 may be TBS₂, the transmit block size of PUSCH #3 may be TBS₃, and the transmit block size of PUSCH #4 may be TBS₄. The data size for logical channel 1 is denoted by TS_{1,1}, the data size for logical channel 2 is denoted by TS_{2,1}, and the data size for logical channel 3 is denoted by TS_{3,1}, which should be transmitted first to satisfy the PBR.

Even after scheduling all data that needs to be transmitted preferentially to satisfy PBR, wireless resources may remain. In this case, within the transmittable MCS index or spectral efficiency according to the priorities of the logical channels, the size of data that can be additionally transmitted is calculated based on Equation 6 described above. The data size to be additionally transmitted for the logical channel 1 is indicated as TS_{1,2}, for logical channel 2 is indicated as TS_{2,2}, and for logical channel 3 is indicated as TS_{3,2}.

The size of data to be transmitted for each logical channel is indicated as TS₁ for logical channel 1, TS₂ for logical channel 2, and TS₃ for logical channel 3. As described above in Equation 7, there is a relationship of TS₁=TS_{1,1}+TS_{1,2}, TS₂=TS_{2,1}+TS_{2,2}, and TS₃=TS_{3,1}+TS_{3,2}.

The UE schedules and transmits TSᵢ size data according to the priority of the logical channels. For example, if the physical channel MCS index of PUSCH #1 and #2 is 10, the physical channel MCS index of PUSCH #3 is 11, and the physical channel MCS index of PUSCH #4 is 13, LCH1 can be transmitted through PUSCH #1 and 2, LCH2 can be transmitted through PUSCH #2 and 3, and LCH3 can be transmitted through PUSCH #3 and 4 according to the above scheduling. As a result, all logical channels can be transmitted while satisfying their respective QoS.

As shown in FIG. 22, according to the present disclosure, when a plurality of data with different target BLERs is scheduled to a single DCI and transmitted over a plurality of PUSCHs, it may be transmitted over a PUSCH that satisfies the QoS of each data. This shows that FIG. 16 has an advantageous effect compared to the prior art. In addition, it can be transmitted through PUSCH that satisfies the QoS of each data while minimizing the size increase in DCI for multi-TTI scheduling, which schedules multiple data channels.

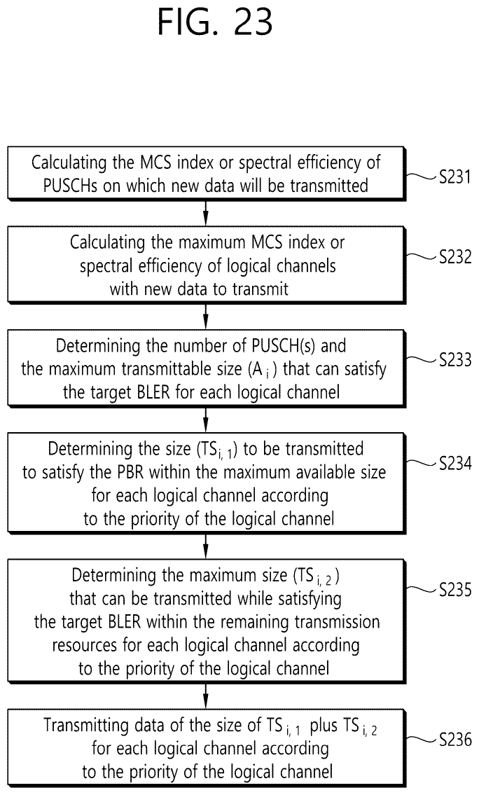

FIG. 23 illustrates the scheduling procedure of the UE.

Referring to FIG. 23, the UE calculates the MCS index or spectral efficiency of PUSCHs on which new data will be transmitted (S231).

The UE calculates the maximum MCS index or spectral efficiency of logical channels with new data to transmit (S232).

The UE determines the number of PUSCH(s) and the maximum transmittable size (Aᵢ) that can satisfy the target BLER for each logical channel (S233).

The UE determines the size (TS_{i,1}) to be transmitted to satisfy the PBR within the maximum available size for each logical channel according to the priority of the logical channel (S234).

The UE determines the maximum size (TS_{i,2}) that can be transmitted while satisfying the target BLER within the remaining transmission resources for each logical channel according to the priority of the logical channel (S235).

The UE transmits data of the size of TS_{i,1} plus TS_{i,2} for each logical channel according to the priority of the logical channel (S236).

This disclosure presents a method and procedure that can satisfy the transmission quality required for each logical channel in a system that schedules multiple PUSCHs with one DCI. In a technology that schedules and transmits multiple data streams with different target BLERs through one DCI, there is an advantageous effect of increasing frequency transmission efficiency and lowering power consumption of the UE while satisfying the QoS for each data stream.

The technical features of the present disclosure may be embodied directly in hardware, in a software executed by a processor, or in a combination of the two. For example, a method performed by a wireless device in a wireless communication may be implemented in hardware, software, firmware, or any combination thereof. For example, a software may reside in RAM, flash memory, ROM, EPROM, EEPROM, registers, hard disk, a removable disk, a CD-ROM, or any other storage medium.

Some example of storage medium may be coupled to the processor such that the processor can read information from the storage medium. In the alternative, the storage medium may be integral to the processor. The processor and the storage medium may reside in an ASIC. For other example, the processor and the storage medium may reside as discrete components.

The computer-readable medium may include a tangible and non-transitory computer-readable storage medium.

For example, non-transitory computer-readable media may include RAM such as synchronous dynamic random access memory (SDRAM), ROM, non-volatile random access memory (NVRAM), EEPROM, flash memory, magnetic or optical data storage media, or any other medium that can be used to store instructions or data structures. Non-transitory computer-readable media may also include combinations of the above.

In addition, the method described herein may be realized at least in part by a computer-readable communication medium that carries or communicates code in the form of instructions or data structures and that can be accessed, read, and/or executed by a computer.

According to some implementations of the present disclosure, a non-transitory computer-readable medium (CRM) has stored thereon a plurality of instructions.

More specifically, the CRM stores instructions that cause operations to be performed by one or more processors. The operation comprises: receiving from the base station, via a higher layer signal, a logical channel modulation and coding scheme (MCS) related value for each of the plurality of logical channels; receiving from the base station one downlink control information (DCI) related to scheduling of the plurality of PUSCHs; and transmitting to the base station the plurality of logical channels via the plurality of PUSCHs based on the higher layer signal and the DCI. In this case, the physical channel MCS value for each of the plurality of PUSCHs is determined based on the DCI, and each of the plurality of logical channels is transmitted only over a PUSCH having a physical channel MCS value that does not exceed its logical channel MCS value.

The effects that may be derived from the specific examples of the present disclosure are not limited to those listed above. For example, there may be a variety of technical effects that a person having ordinary skill in the related art may understand or induce from the disclosure. Accordingly, the specific effects of the present disclosure are not limited to those expressly described herein, but may include a variety of effects that may be understood or induced from the technical features of the present disclosure.

The claims described herein may be combined in various ways. For example, a combination of the technical features of the method claims of this specification may be implemented as an apparatus, and a combination of the technical features of the apparatus claims of this specification may be implemented as a method. Further, a combination of technical features of the method claims of this specification and technical features of the apparatus claims of this specification may be implemented as an apparatus, and a combination of technical features of the method claims of this specification and technical features of the apparatus claims of this specification may be implemented as a method. Other implementations are within the scope of the following claims.

1. A method of transmitting a physical uplink shared channel (PUSCH) of a user equipment (UE) in a wireless communication system, the method comprising:
receiving, via a higher layer signal, a logical channel modulation and coding scheme (MCS) related value for each of a plurality of logical channels; and
receiving one downlink control information (DCI) related with scheduling of a plurality of PUSCHs; and
transmitting the plurality of logical channels through the plurality of PUSCHs based on the higher layer signal and the DCI,
wherein a physical channel MCS value for each of the plurality of PUSCHs is determined based on the DCI,
wherein each of the plurality of logical channels is transmitted only through a PUSCH having a physical channel MCS value that does not exceed its logical channel MCS value.

2. The method of claim 1, wherein the DCI comprises information indicating which of the plurality of PUSCHs is a transmission reference logical channel that is transmitted over a PUSCH with a smallest physical channel MCS value.

3. The method of claim 1, wherein the DCI provides physical channel MCS values of the plurality of PUSCHs, via reference MCS index and MCS index offset values.

4. The method of claim 1, wherein the logical channel MCS value is given based on a corresponding target block error ratio (BLER) or spectral efficiency.

5. The method of claim 1, wherein the DCI is received through a physical downlink control channel (PDCCH).

6. The method of claim 1, wherein the higher layer signal is a radio resource control (RRC) message or a medium access control (MAC) control element (CE).

7. The method of claim 1, further comprising:
obtaining a physical channel MCS value for each of the plurality of PUSCHs based on the DCI,
obtaining a logical channel MCS value for each of the plurality of logical channels,
determining, based on the physical channel MCS value and the logical channel MCS value, a number of PUSCHs and a maximum transmittable size (Aᵢ) of each of the plurality of logical channels that can satisfy a target BLER,
determining, based on a priority of each of the plurality of logical channels, a size (TS_{i,1}) that should be transmitted to satisfy the prioritised bit rate (PBR) within a maximum available size for each of the logical channels,
determining, for each of the logical channels, a maximum size (TS_{i,2}) that can be transmitted while satisfying a target BLER within remaining transmission resources for each of the logical channels according to a priority of each of the logical channels; and
transmitting data of a size equal to the TS_{i,1} plus TS_{i,2} for each of the logical channels based on a priority of the each of the logical channels.

8. The method of claim 1, wherein an initial configuration of logical channel MCS related values for each of the plurality of logical channels is received via an RRC message,
wherein a change configuration of the logical channel MCS related values is received via a medium access control (MAC) control element (CE).

9. The method of claim 1, wherein logical channel MCS related value for each of the plurality of logical channels comprises at least one of a difference value of the MCS index of each logical channel relative to a reference logical channel and a spectral efficiency multiplier.

10. The method of claim 9, wherein the DCI further comprises a sequential number,
wherein, among configuration information including a logical channel MCS related value for each of the plurality of logical channels, an MCS index difference value or a spectral efficiency multiplier included in configuration information corresponding to the sequential number is used to determine a logical channel to be transmitted via the plurality of PUSCHs.

11. A user equipment (UE) operated in a wireless communication system, the UE comprising:
at least one transceiver;
at least one processor; and
at least one memory operably coupled to the at least one processor,
wherein the at least one processor is adapted to:
receive, via a higher layer signal, a logical channel modulation and coding scheme (MCS) related value for each of a plurality of logical channels; and
receive one downlink control information (DCI) related with scheduling of a plurality of PUSCHs; and
transmit the plurality of logical channels through the plurality of PUSCHs based on the higher layer signal and the DCI,
wherein a physical channel MCS value for each of the plurality of PUSCHs is determined based on the DCI,
wherein each of the plurality of logical channels is transmitted only through a PUSCH having a physical channel MCS value that does not exceed its logical channel MCS value.

12-13. (canceled)

14. A method of operating a base station in a wireless communication system, the method comprising:
transmitting, via a higher layer signal, a logical channel modulation and coding scheme (MCS) related value for each of a plurality of logical channels to a user equipment (UE); and
transmitting one downlink control information (DCI) related with scheduling of a plurality of PUSCHs to the UE; and
receiving the plurality of logical channels through the plurality of PUSCHs,
wherein a physical channel MCS value for each of the plurality of PUSCHs is determined based on the DCI,
wherein each of the plurality of logical channels is received only through a PUSCH having a physical channel MCS value that does not exceed its logical channel MCS value.

15. (canceled)
